(19) United States
(12) Patent Application Publication
(10) Pub. No.: US 2006/0039711 A1
(43) Pub. Date: Feb. 23, 2006

(54) Image forming apparatus

(75) Inventors: Satoru Shibuya, Aichi-ken (JP); Yasunori Nakayama, Aichi-ken (JP); Hidetoshi Noguchi, Aichi-ken (JP); Hideo Yamaki, Toyokawa-shi (JP); Yasuo Tanaka, Okazaki-shi (JP); Hideji Higashimura, Toyokawa-shi (JP); Tomohide Mori, Okazaki-shi (JP)

Correspondence Address: Barry E. Bretschneider;Morrison & Foerster LLP, Suite 300, 1650 Tysons Boulevard, McLean, VA, 22102, US

(73) Assignee: Konica Minolta Business Technologies, Inc., Tokyo (JP)

(21) Appl. No.: 11/019,034

(22) Filed: Dec. 22, 2004

(30) Foreign Application Priority Data
Aug. 18, 2004 (JP) 2004-238073

(51) Int. Cl. G03G 15/00; G03G 21/00

(52) U.S. Cl. 399/44; 399/353; 399/71

(57) ABSTRACT

An image forming apparatus has a control section. The control section controls a power supply for applying a bias voltage to a cleaning brush and a driving mechanism for the cleaning brush so that the cleaning brush 41 begins to rotate when a predetermined delay time has passed after the start of the application of the bias voltage to cleaning brush. Toner remaining on an image bearing body at an upstream side of a nip portion between the cleaning brush and the image bearing body is surely removed.

### RELATED APPLICATION

This application is based on Japanese Patent Application No. 2004-238073, the contents in which are incorporated herein by reference.

### BACKGROUND TECHNOLOGY

The present invention relates to an image forming apparatus such as a laser printer, a copier, a facsimile apparatus, and a multiple function machine of these apparatuses.

An image forming apparatus is provided with cleaning devices for collecting toner remaining on surfaces of a photoconductive body (photoconductive drum or photoconductive belt) as an image bearing body and the intermediate transfer body (intermediate transfer belt or intermediate transfer drum).

As shown in FIG. 19, a cleaning device is known that comprises: a cleaning brush 2 rotating with contacting to an image bearing body 1, a collection roller 3 rotating with contacting to the cleaning brush 2, and a scraper 4 being fixed and contacting to the collection roller 3. The cleaning brush 2 is provided with a large number of hairs or brush fibers 2b implanted in an outer periphery of a core metal 2a. Toner 5 on a surface of the image bearing body 1 is mechanically scraped by the brush fibers 2b of the cleaning brush 2. A bias voltage of a polarity reverse to a charging polarity for the toner 5 is applied to the cleaning brush 2. For example, when a normal charging polarity of the toner 5 is negative, the bias voltage of positive polarity is applied to the cleaning brush 2. This bias voltage generates an electric field between the cleaning brush 2 and the image bearing body 1, so that the toner 5 is electro-statically adsorbed to the cleaning brush 2. The toner 5 collected by the cleaning brush 2 moves to the collection roller 3 owing to a potential difference between the cleaning brush 2 and the collection roller 3. The toner 5 on the surface of the collection roller 3 is mechanically scraped by the scraper 4. U.S. Pat. No. 5,600,405, Japan Laid-open Patent Application 2000-39,284, and U.S. Pat. No. 5,561,513 disclose image forming apparatuses provided with such types of cleaning devices.

While the image formation operation is stopped, i.e., while the rotations of cleaning brush 2 and image bearing body 1 are stopped, toner 5 often remains on the image bearing body 1 at the upstream side with respect to a nip portion between the cleaning brush 2 and image bearing body 1 in a rotational direction of the image bearing body 1. In the conventional image forming apparatus, application of the bias voltage to cleaning brush 2, rotation of cleaning brush 2, and rotation of image bearing body 1 are started simultaneously. Therefore, before the bias voltage increases to a value sufficient for making brush fibers 2a electro-statically attract toner 5 and a rotational speed of the cleaning brush 2 has increased to the speed sufficient for making brush fibers 2a mechanically scrape off the toner 5, the toner 5 remaining at the upstream side of the nip portion reaches the nip portion. This results in that the toner 5 that has remained at the upstream side to the nip portion while the image formation operation is stopped passes through the nip portion without being removed by cleaning brush 2. The toner 5 that has passed through the nip portion adheres to a top side of a recording medium such as a sheet of paper (an image formation surface in the case of a one-side printing). Further, when toner 5 that has passed through the nip portion adheres to the transfer roller of the transfer device, it adheres to a rear side of the recording medium (a non-image formation surface in the case of the one-side printing).

In the case where jamming of the recording medium occurs, the image forming apparatus stops in a state that a toner image that has not yet been transferred remains on the image bearing body 1 as it is. Therefore, a large amount of toner 5 remains on image bearing body 1 at the time of a first operation after the jam has been treated. Further, the amount of toner existing on the image bearing body 1 is greater at a time of an image stabilization process (the image concentration adjustment and resist adjustment) than at a time of a normal image formation. As described above, the amount of toner 5 existing on the surface of the image bearing body 1 varies due to a variety factors. Thus, it is necessary to surely or without fail remove the toner 5 that has remained on image bearing body 1 in accordance with such factors.

### SUMMARY OF THE INVENTION

A first object of the present invention is to surely remove the toner remaining on the image bearing body at the upstream side with respect to the nip portion between the cleaning brush and the image bearing body while the image formation operation is stopped by the cleaning brush.

A second object of the present invention is to surely remove the toner on the image bearing body when jamming has occurred, or during the image stabilization process.

A first aspect of the present invention provides an image forming apparatus comprises an image bearing body for bearing a toner image on a surface thereof, a cleaning brush with a plurality of brush fibers on an outer periphery arranged so as to be rotatable in a state that the brush fibers are contacting with the image bearing body, a first driving section for rotating the cleaning brush, a bias voltage apply section for applying a bias voltage to the cleaning brush, and a control section for controlling the first driving section and the bias voltage application section so that the cleaning brush begins to rotate after a predetermined first delay time has passed from starting of an application of the bias voltage to the cleaning brush.

While the rotations of the cleaning brush and the image bearing body are stopped, the toner often remains on the image bearing body on the upstream side with respect to a nip portion between the cleaning brush and the image bearing body in the rotational direction (forward rotational direction) of the image bearing body. The cleaning brush begins to rotate after the first delay time has passed after starting of the application of the bias voltage to the cleaning brush, and therefore, mechanical scraping off of the toner by the brush fibers is started after the bias voltage has increased to a value sufficient for the brush fibers to electro statically attract toner. Accordingly, the toner remaining on the image bearing body on the upstream side of the nip portion can be prevented from passing through the nip portion without being removed by the cleaning brush, causing inadequate cleaning. In other words, the toner remaining on the image bearing body on the upstream side of the nip portion can be removed without fail by the cleaning brush, increasing the cleaning efficiency. For example, the first delay time is set to a value in the range from approximately 0.1 second to 1.0 second.

Further, the image forming apparatus further comprises a second driving section for rotating the image bearing body. The control section controls the second driving section so that the image bearing body begins to rotate after a predetermined second delay time has passed from starting of the rotation of the cleaning brush.

The image bearing body begins to rotate after the second delay time has additionally passed after the starting of the rotation of the cleaning brush following the start of the application of a bias voltage. Accordingly, the toner remaining on the image bearing body on the upstream side of the nip portion reaches the nip portion after the bias voltage and the rotational speed of the cleaning brush have sufficiently increased. In other words, the toner remaining on the image bearing body on the upstream side of the nip portion reaches the nip portion after both the effect of electro statically removing the toner and the effect of removing the toner by mechanical scraping have sufficiently been enhanced. Accordingly, the toner remaining on the image bearing body on the upstream side of the nip portion can be more efficiently prevented from passing through the nip portion without being removed by the cleaning brush. For example, the second delay time is set to a value in the range from approximately 0.7 seconds to 2.0 seconds.

Furthermore, the image forming apparatus further comprises a rotatable transfer roller for transferring the toner image on the image bearing body to a recording medium; and a third driving section for moving the transfer roller between a first position where the transfer roller is in contact with the image bearing body and a second position where the transfer roller is spaced to the image bearing body. The control section controls the third driving section so that the transfer roller shifts from the second position to the first position after a predetermined third delay time has passed from starting of the rotation of the image bearing body.

The transfer roller is shifted from the second position to the first position so as to make contact with the image bearing body after a third delay time has additionally passed after the start of the rotation of the image bearing body following the application of the bias voltage and the start of the rotation of the cleaning brush. Accordingly, the transfer roller makes contact with the image bearing body after the toner remaining on the image bearing body on the upstream side of the nip portion has been removed by the cleaning brush. Therefore, the toner remaining on the image bearing body on the upstream side of the nip portion can be prevented from reaching and adhering to the transfer roller. For example, the third delay time is set to a value in the range from approximately 0.7 seconds to 2.0 seconds.

It is preferable that the control section controls the first driving section and the bias voltage application section so that the application of a bias voltage to the cleaning brush is stopped after a predetermined fourth delay time has passed after the rotation of the cleaning brush has stopped.

The application of the bias voltage to the cleaning brush is maintained before a fourth delay time has passed after the rotation of the cleaning brush has stopped, i.e., until the cleaning brush has completely stopped rotating. This maintains the effect of the brush fibers of the cleaning brush of electro statically attracting the toner on the image bearing body. Accordingly, the toner can be prevented from remaining on the image bearing body on the upstream side of the nip portion between the cleaning brush and the image bearing body. For example, the fourth delay time is set to a value in the range from approximately 1.0 second to 2.0 seconds.

In addition, it is preferable that the control section controls the first driving section and the second driving section so that the rotation of the cleaning brush is stopped after a predetermined fifth delay time has passed after the rotation of the image bearing body has stopped.

Before a fifth delay time has passed after the rotation of the image bearing body has stopped, i.e., until the image bearing body completely stops to rotate, the cleaning brush continuously rotates to maintain the effect of the brush fibers of the cleaning brush of mechanically scraping off the toner on the image bearing body. Accordingly, the toner can be prevented from remaining on the image bearing body on the upstream side with respect to the nip portion between the cleaning brush and the image bearing body.

A second aspect of the present invention provides an image forming apparatus comprising a rotatable image bearing body for bearing a toner image on a surface thereof, a first driving section for rotating the image bearing body, a cleaning brush with a plurality of brush fibers on an outer periphery arranged so as to be rotatable in a state that brush fibers are contacting with the image bearing body, a second driving section for rotating the cleaning brush, a bias voltage applying section for applying a bias voltage to the cleaning brush; and a control section for controlling the first driving section, second driving section, and bias voltage applying section so that the image bearing body rotates in a forward rotational direction, the cleaning brush rotates, and the bias voltage is applied to the cleaning brush during the image formation operation, and the image bearing body rotates in a reverse rotational direction for a predetermined period of time after a completion of one image formation operation and before a start of a next image formation operation.

The image bearing body rotates in the reverse rotational direction for the predetermined period of time after the completion of one image formation operation and before the next image formation operation. Therefore, the toner remaining on the image bearing body on the upstream side with respect to the nip portion between the cleaning brush and the image bearing body is once shifted from the nip portion to the upstream side of the image bearing body in the forward rotational direction. Accordingly, the bias voltage and the rotational speed of the cleaning brush have sufficiently increased at the time when the image bearing body rotates in the forward rotational direction and the toner remaining on the surface of the image bearing body on the upstream side to the nip portion passes through the nip portion when the image formation operation begins. Therefore, the toner remaining on the image bearing body on the upstream side of the nip portion can be prevented from passing through the nip portion without being removed by the cleaning brush, causing inadequate cleaning. In other words, the toner remaining on the image bearing body on the upstream side with respect to the nip portion can be surely removed by the cleaning brush, increasing the cleaning efficiency. For example, the time for rotating the image bearing body in the reverse rotational direction is set to a value in the range from approximately 0.7 seconds to 2.0 seconds.

Specifically, the control section controls the first driving section, second driving section, and bias voltage applying section so that at starting of the image formation, the rotation of the image bearing body in the forward rotational direction, the rotation of the cleaning brush, and the application of a bias voltage to the cleaning brush are started after the rotation of the image bearing body in the reverse rotational direction for the predetermined period of time.

Alternatively, the control section controls the first driving section, second driving section, and bias voltage applying section so that while the image formation is stopped, the rotation of the cleaning brush and the application of the bias voltage is started after the image bearing body rotates in the reverse rotational direction for a predetermined period of time.

The image forming apparatus may further a rotatable transfer roller for transferring the toner image on the image bearing body onto a recording medium, and a third driving section for moving the transfer roller between a first position where the transfer roller is in contact with the image bearing body and a second position where the transfer roller is spaced to the image bearing body. In this case, the control section controls the third driving section so that at the starting of the imager formation operation, the transfer roller shifts from the second position to the first position after a predetermined delay time has passed after the starting of the rotation of the image bearing body in the forward rotational direction.

The transfer roller that has been in the second position where it is spaced to the image bearing body is shifted to the second position where it is in contact with the image bearing body after the toner remaining on the image bearing body on the upstream side with respect to the nip portion has been removed by the cleaning brush. Accordingly, the toner remaining on the image bearing body on the upstream side of the nip portion can be prevented from reaching and adhering to the transfer roller. For example, the delay time is set to a value in the range from approximately 4.8 seconds to 9.0 seconds.

A third aspect of the present invention provides an image forming apparatus comprising an image bearing body for bearing a toner image on a surface thereof, a transfer device for transferring the toner image formed on the image bearing body onto a recording medium, a cleaning brush with a plurality of brush fibers on an outer periphery placed so as to be rotatable in a state that the brush fibers are in contact with the image bearing body, a driving section for rotating the cleaning brush, and a control section for controlling the driving section so that a rotational speed of the cleaning brush are increased during an image stabilization process.

When jamming occurs, the toner image remains on the intermediate transfer belt without being transferred to a recording medium, and therefore, the amount of toner on the image bearing body is greater than at a normal time. Accordingly, the toner on the image bearing body can be efficiently removed by increasing the rotational speed of the cleaning brush at the time of the first operation after the occurrence of the jam. When the ratio of the rotational speed of the cleaning brush to that of the image bearing body at the time of the normal-operation (first rotational speed) is approximately 1.5, the corresponding ratio of the rotational speed at the time of the initial operation after the occurrence of the jam (second rotational speed) is set to approximately 2.0.

A fourth aspect of the present invention provides an image forming apparatus comprising, an image bearing body for bearing a toner image on a surface thereof, a transfer device for transferring the toner image formed on the image bearing body onto a recording medium, a cleaning brush with a plurality of brush fibers on an outer periphery placed so as to be rotatable in a state that the brush fibers are in contact with the image bearing body, a driving section for rotating the cleaning brush, and a control section for controlling the driving section so that a rotational speed of the cleaning brush are increased during an image stabilization process.

The image stabilization process includes image density adjustment and resist adjustment. During the image density adjustment and the resist adjustment, a larger amount of toner is carried on the image bearing body than in the case of normal image formation. Accordingly, the toner on the image bearing body can be efficiently removed by increasing the rotational speed of the cleaning brush during the stabilization process. When the ratio of the rotational speed of the cleaning brush to that of the image bearing body at a normal time (first rotational speed) is approximately 1.5, for example, the corresponding ratio of the rotational speed during the image stabilization process (second rotational speed)is set to approximately 2.0.

According to the first aspect of the present invention, the cleaning brush starts rotating after the predetermined delay time has passed from starting of the application of the bias voltage to the cleaning brush. Therefore, the toner remaining on the upstream side with respect to the nip portion between the cleaning brush and the image bearing body can be surely removed by the cleaning brush, increasing the cleaning efficiency.

According to the second aspect of the present invention, the image bearing body rotates in the reverse rotational direction for the predetermined period of time after the completion of one image formation operation and before the starting of the next image formation operation. Thereby, the toner remaining on the upstream side with respect to the nip portion between the cleaning brush and the image bearing body can be surely removed by the cleaning brush, increasing the cleaning efficiency.

According to the third and fourth aspect of the present invention, the rotational speed of the cleaning brush is increased at the time of the first operation after the occurrence of the jam, or during the image stabilization process. Thereby, the toner remaining on the image bearing body can be efficiently removed.

### BRIEF DESCRIPTION OF THE DRAWINGS

These and other objects and features of the invention will become apparent from the following description taken in conjunction with preferred embodiments of the invention with reference to the accompanying drawings, in which:

FIG. 1 is a schematic configuration diagram showing an image forming apparatus according to the first embodiment of the present invention;

FIG. 2 is a cross-sectional diagram showing a cleaning device;

FIG. 3 is a schematic diagram showing the cleaning device and a secondary transfer device;

FIG. 4 is a flow chart illustrating an operation of the image forming apparatus;

FIG. 5 is a flow chart illustrating an operation of the cleaning device and the operations of an intermediate transfer belt and the secondary transfer device that relate to the cleaning device;

FIG. 6 is a flow chart illustrating a setting routine in the first embodiment of the present invention;

FIG. 7A is a flow chart illustrating a driving routine in the first embodiment of the present invention;

FIG. 7B is a flow chart illustrating the driving routine in the first embodiment of the present invention;

FIG. 8A is a graph showing the relationship between the ratio of the rotational speed of the cleaning brush to that of the intermediate transfer belt concerning toner charged-to a normal polarity and toner charged to a reverse polarity, and the cleaning the performance;

FIG. 8B is a graph showing the relationship between the ratio of the rotational speed of the cleaning brush to that of the intermediate transfer belt concerning toner remaining after transfer and toner before transfer, and the cleaning the performance;

FIG. 9 is a timing chart of an application of a bias, rotation of the cleaning brush, rotation of the intermediate transfer belt, and driving of a solenoid in the first embodiment of the present invention;

FIG. 10A is a timing chart showing first modification of the first embodiment;

FIG. 10B is a timing chart showing second modification of the first embodiment;

FIG. 11A is a timing chart showing third modification of the first embodiment;

FIG. 11B is a timing chart showing fourth modification of the first embodiment;

FIG. 12A is a flow chart showing the driving routine in the second embodiment of the present invention;

FIG. 12B is a flow chart showing the driving routine in the second embodiment of the present invention;

FIG. 13 is a timing chart of the application of a bias, the rotation of the cleaning brush, the rotation of the intermediate transfer belt, and the driving of a solenoid in the second embodiment of the present invention;

FIG. 14 is a schematic diagram showing a cleaning device for illustrating a principle of increase in the cleaning performance due to the reverse rotational operation of the intermediate transfer belt;

FIG. 15 is a timing chart showing a modification of the second embodiment;

FIG. 16A is a flow chart showing the driving routine in the third embodiment of the present invention;

FIG. 16B is a flow chart showing the driving routine in the third embodiment of the present invention;

FIG. 17 is a timing chart of the application of a bias, the rotation of the cleaning brush, the rotation of the intermediate transfer belt, and the driving of a solenoid in the third embodiment;

FIG. 18 is a timing chart showing a modification of the present invention; and

FIG. 19 is a schematic diagram showing an example of a cleaning device according of the prior art.

### DESCRIPTION OF THE PREFERRED EMBODIMENTS

### First Embodiment

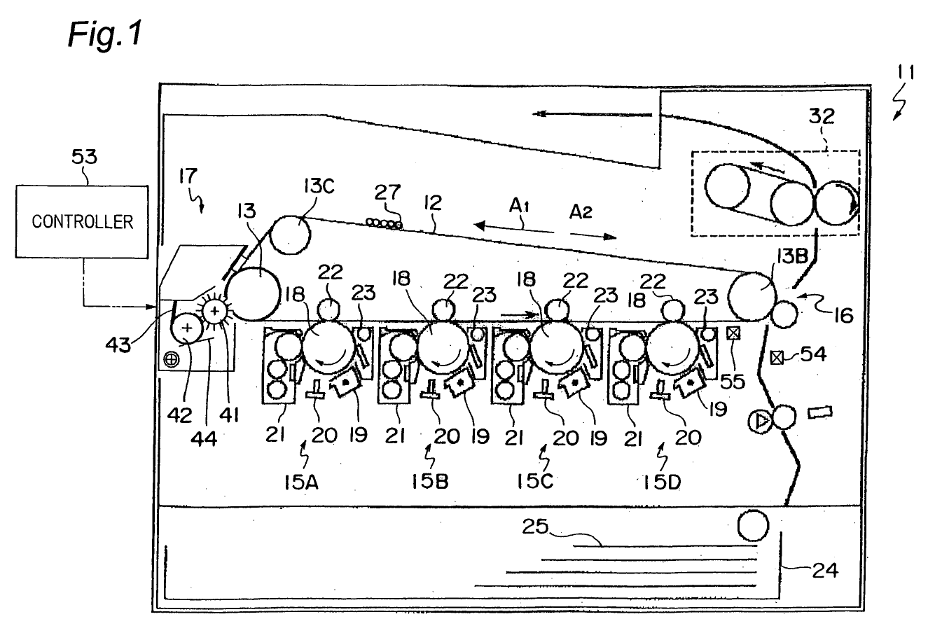

FIG. 1 shows a laser printer 11 of tandem process type serving as an image forming apparatus according to an embodiment of the present invention. In the present embodiment, a normal charging polarity of toner is assumed to be negative.

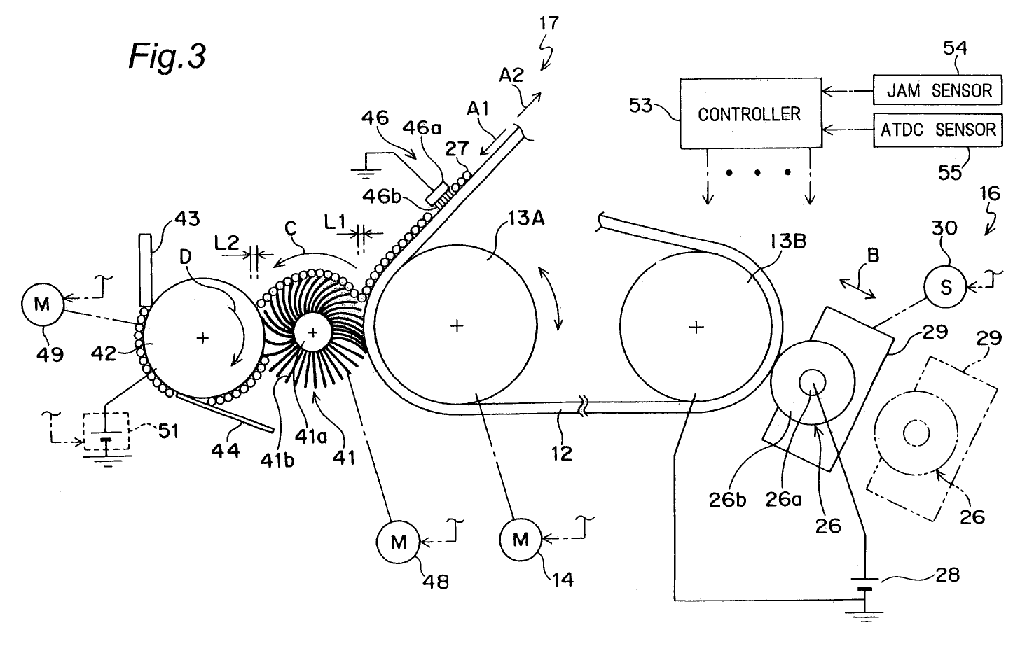

An intermediate transfer belt 12 (hereinafter simply referred to as transfer belt) stretches on three rollers 13A, 13B and 13C. Of these three rollers 13A to 13C, one roller 13A (driving roller) is mechanically connected to a driving mechanism 14 (see FIG. 3) that includes a motor and transmission elements, while remaining rollers 13B and 13C (passive rollers) are rotated by intermediate transfer belt 12. Driving mechanism 14 can rotate the transfer belt 12 in both of a forward rotational direction indicated by arrow Al and a reverse rotational direction indicated by arrow A2. Around the transfer belt 12, there are disposed first to fourth image formation units 15A to 15D, a secondary transfer device 16 and a secondary cleaning device 17 (hereinafter simply referred to as cleaning device).

The image forming units 15A-15D respectively transfers images of yellow (Y), magenta (M), cyan (C), and black (Br) onto the transfer belt 12. The image forming units 15A-15D have the same structure with each other, and each unit comprises a charging device 19, an exposure device 20, a developing device 21, a primary transfer device 22, and a primary cleaning device 23, which are arranged around a photoconductor drum 17. The surface of the photoconductor drum 18 uniformly charged by the charging device 19 undergoes the process of exposure with laser light projected from the exposure device 20, so that an electrostatic latent image is formed. The electrostatic latent image is developed into a toner image with toner supplied from the developing device 21. The toner image is transferred electrostatically to the surface of the transfer belt 12 by a positive voltage applied on a backside of the transfer belt 12 by the primary transfer device 22. The toner remaining on the surface of the photoconductor drum 18 after the primary transfer is collected by the primary cleaning device 23.

In case of a color image, a toner image is transferred and overlaid onto the transfer belt 12 at each time when the transfer belt 12 passes through each of the image forming units 15A-15D. In contrast, in case of a monochromatic image, a toner image is transferred to the transfer belt 12 only by the image forming unit 15D. The toner image transferred to the transfer belt 12 is electrostatically transferred by the secondary transfer device 16 onto a recording medium 24 such as a paper sheet transported from a paper feed cassette 23. The recording medium 25 carrying the toner image is transported to a fixing device 32, so that the image is fixed on the recording medium 25 by pressurization and heating.

Further referring to FIG. 3, the secondary transfer device 16 is provided with secondary transfer roller 26 placed so as to opposite to the passive roller 13B. The secondary transfer roller 26 has a core metal 26a composed of a solid or hollow rod formed of a conductive material such as a metal, and an elastic layer 26b formed around this core metal 26a. The elastic layer 26b is made of, for example, urethane foam which has been made conductive. The secondary transfer roller 26 is electrically connected to a power supply 28. The power supply 28 applies a secondary transfer voltage to the secondary transfer roller 26. The secondary transfer voltage has the polarity (positive polarity in the present embodiment) opposite to the polarity of the normal charge of toner 27 on the transfer belt 12. Passive roller 13B, on the other hand, is grounded.

Secondary transfer roller 26 is rotatably supported by a support member 29. As indicated by an arrow B, the support member 29 is movable in a reciprocally translatable manner by a driving mechanism 30 including a solenoid and transmission elements. Therefore, the secondary transfer roller 26 is movable between a first position where it is in contact with transfer belt 12 as shown by the solid line, and the second position where it is spaced to the transfer belt 12 as shown by the two-dot chain line. In the present embodiment, a plunger of the solenoid of the driving mechanism 30 is at a retracted position when the solenoid is un-energized. At this time, the secondary transfer roller 26 is in the second position and spaced to the from transfer belt 12. On the other hand, the plunger of the solenoid is in a protruded position when the solenoid is energized. At this time, the secondary transfer roller 26 is in the first position and in contact with the transfer belt 12.

When recording medium 25 is supplied to the nip portion between the secondary transfer roller 26 and transfer belt 12, the toner image is transferred from transfer belt 12 onto recording medium 25 by the voltage applied from the power supply 28 to the back surface of the recording medium 25.

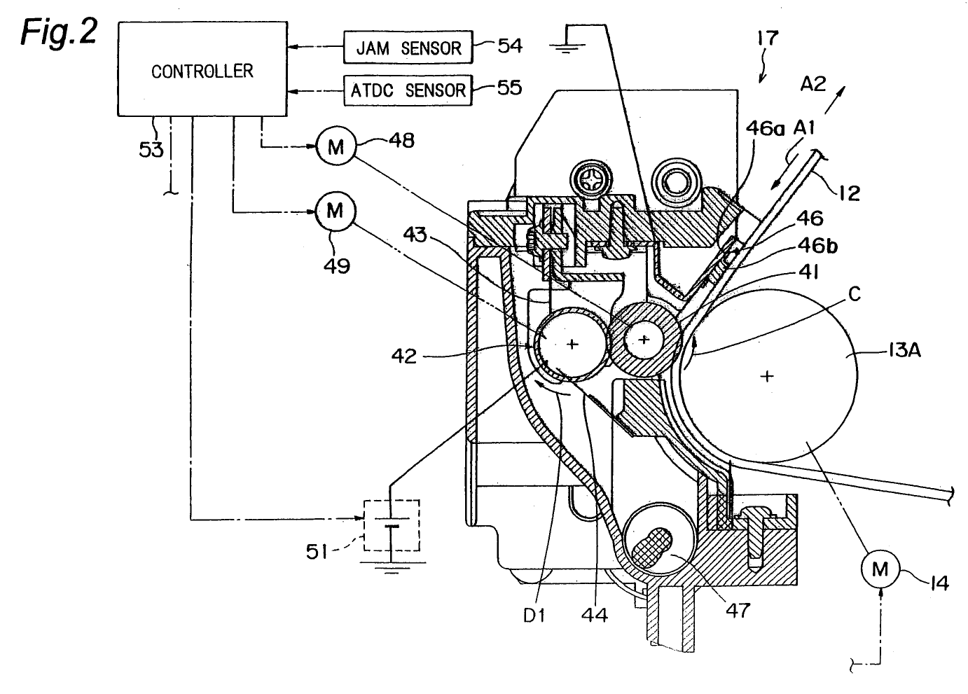

Referring to FIGS. 2 and 3, cleaning device 17 is provided with a cleaning brush 41, collection roller 42, scraper 43, a seal member 44, conductive brush 46, and a conveying screw 47 (shown only in FIG. 2).

As shown in FIG. 3, cleaning brush 41 is provided with a core metal 41a composed of a solid or hollow rod made of a conductive material such as a metal, and a large number of electrically conductive hairs or brush fibers 41b implanted in an outer periphery of the core metal 41a. More specifically, the brush fibers 41b are woven into an electrically conductive fabric substrate which is wound and bonded around the core metal 41a. The fabric substrate may be coated with electrically conductive agent on the side facing the core metal 31a or on both sides. The brush fibers 41b are composed of resin such as nylon, polyester, acrylic, rayon, or the like in which carbon is dispersed for electrical conductivity. The brush fibers 41b has a fibril diameter of approximately 1-10 D, a fibril density of approximately 50-300 kF, and a fibril resistance of approximately 10³ Ω or higher. In the present embodiment, each of the brush fibers 41b has a fibril diameter of 6 D, a fibril density of approximately 75-100 kF, and a fibril resistance of 10⁶-10¹¹ Ω.

The cleaning brush 41 contacts with the transfer belt 12 in a state that a nip portion is formed. The amount L1 of the nip portion of the cleaning brush 31 against the transfer belt 12 (see FIG. 3) is set within a range of approximately 0.5-2.0 mm, and is 1.0 mm in the present embodiment.

The cleaning brush 41 is supported so as to be rotatable around the axis of rotation of core metal 41a, and is driven to be rotated by a drive mechanism 48 including a motor and a transmission mechanism. In the present embodiment, as shown in FIG. 3, a rotational direction (arrow C) of the cleaning brush 41 is reverse to a rotational direction (arrow A1) of the transfer belt 12. In other words, when the transfer belt 12 rotates in the normal direction, the cleaning brush 41 and the transfer belt 12 move in the reverse directions with each other at a contact area between them. As described later in detail, the drive mechanism 48 can adjust a rotation rate (number of rotations per unit time) of the cleaning brush 31.

The collection roller 42 is composed of a solid or hollow bar formed with an electrically conductive material such as metal and electrically conductive resin. The surface of the collection roller 42 may be processed by polishing, plating, coating, or the like in order to reduce the friction. Such processing suppresses the wear in the scraper 43 at the point of contact with the collection roller 42, and further improves the collection performance for the toner 27.

The collection roller 42 contacts with the cleaning brush 41 in a state that a nip portion is formed. The amount L2 (see FIG. 3) of the nip portion of the collection roller 42 against the cleaning brush 41 is set within a range of approximately 0.5-2.0 mm, and is 1.0 mm in the present embodiment.

The collection roller 42 is rotatably supported, and driven to be rotated by a drive mechanism 49 including a motor and a transmission mechanism. In the present embodiment, as shown in FIG. 3, a rotational direction (arrow D) of the collection roller 42 is forward relative to the rotational direction (arrow C) of the cleaning brush 41. In other words, the collection roller 42 and the cleaning brush 41 move in the same direction with each other at a contact area between them.

The scraper 43 is composed of a fixed metal or rubber blade. A tip of the scraper 43 is in contact with the surface of the collection roller 42. A pressing angle, nip amount, pressing force, and the like of the scraper 43 are set depending on the type of the toner 27, the material and dimensions of the collection roller 42, and the like. The scraper 43 mechanically scrapes the toner 27 on the surface of the collection roller 42. Thus, the toner 27 is pulverized and scattered. In order to prevent the scattered toner 27 from adhering to the cleaning brush 41, the scraper 43 is preferably arranged away from the cleaning brush 31 by 90° or greater in the downstream of the rotational direction (arrow D) of the collection roller 32. In case that the scraper 43 is composed of a metal blade, it is preferable that the scraper 42 has a acute tip angle and a thin thickness in order that the toner 27 having a small grain size is surely removed. Further, in this case of the metal blade, the tip may be treated by a chemical process such as edging in order to improve precision in the edge contacting with the collection roller 42. Furthermore, the tip of the metal blade may be treated by a friction reducing process such as plating, baking, and coating for preventing tip wear prevention and hardening. In the present embodiment, the scraper 43 is composed of a metal blade of stainless steel, and has a thickness of 0.5 mm. Further, the tip of the scraper 43 is processed by edging.

The seal member 44 prevents that the toner 27 having been pulverized when scraped from the collection roller 42 by the scraper 43 is transported and reattached to the transfer belt 12 by air flow caused by the cleaning brush 41. In the present embodiment, the seal member 44 is made of a plastic film. A tip of the seal member 44 is in surface contact with the surface of the collection roller 42. The contact pressure of the seal member 44 against the collection roller 42 is set at such a low value that the seal member 44 does not scrape the toner 27 on the collection roller 42.

The electrically conductive brush 46 is provided with an electrically conductive base 46a and a large number of electrically conductive brush fibers 46b implanted into the base 46a. The electrically conductive brush 46 is arranged in the upstream of the cleaning brush 41 in the direction of forwarding (arrow A1) of the transfer belt 13. The brush fibers 46b are in contact with the surface of the transfer belt 12. The base 46a is grounded. The electrically conductive brush 46 may be replaced by another electrically conductive member such as an electrically conductive film.

A bias voltage is applied to the cleaning brush 41 from a power supply 51 through the collection roller 42. The polarity of the bias voltage (positive) is reverse to the normal charging polarity for the toner 27 on the transfer belt 12 (negative). More specifically, the power supply 51 is connected to the collection roller 42, so that the cleaning brush 41 is connected indirectly to the power supply 45 via the collection roller 42. Since the electrically conductive brush 46 is grounded as described above, a closed circuit is formed from the power supply 51 to the electrically conductive brush 46 through the collection roller 42, the cleaning brush 41, and the transfer belt 12. Between the brush fibers 41b of the cleaning brush 41 and the transfer belt 12, the current flowing through the closed circuit generates an electric field (cleaning electric field) in a direction generating a force causing the toner 27 of the normal charging polarity to be absorbed electrostatically from the transfer belt 12 to the brush fibers 41b. On the other hand, between the brush fibers 46b of the electrically conductive brush 46 and the transfer belt 12, an electric field is generated in the reverse direction to the cleaning electric field. The circuit for applying the bias voltage to the cleaning brush 41 is not limited to this configuration. For example, the power supply 51 may be a constant current power supply or constant voltage power supply. Further, the power supply 51 may be connected to the core metal 41a of the cleaning brush 41. Furthermore, a power supply may be connected to the electrically conductive brush 46 with the cleaning brush 41 being grounded.

The toner 27 remaining on the transfer belt 12 even after passing through the secondary transfer device 16 (see FIG. 1) reaches the electrically conductive brush 36 and passes the nip portion of the electrically conductive brush 46 against the transfer belt 12. As described above, an electric field in the reverse direction to the cleaning electric field is generated between the electrically conductive brush 46 and the transfer belt 12. Thus, the toner 27 charged in the reverse polarity (positive) to the normal charging polarity is charged into the normal charging polarity (negative) during the passage through the electrically conductive brush 46. At the nip portion between the cleaning brush 41 and the transfer belt 12, the toner 27 is mechanically scraped by the cleaning brush 41 rotating in the reverse direction relative to the transfer belt 12. Further, owing to the cleaning electric field generated between the cleaning brush 41 and the transfer belt 12, the toner 27 on the transfer belt 12 is absorbed electro-statically to the cleaning brush 41. Since the cleaning brush 41 has a potential difference from the collection roller 42, the toner 28 collected by the cleaning brush 41 moves to the collection roller 42. The toner 27 on the collection roller 42 is mechanically scraped off by the scraper 43. The toner 27 scraped by the scraper 43 is transported to the outside of the cleaning device 17 by the conveying screw 47. The seal member 44 prevents that the toner 27 having been pulverized when scraped by the scraper 43 is scattered to the transfer belt 12.

A controller 53 is provided with various components such as a CPU, RAM, ROM, clock, and the like, so as to control an operation of the laser printer 11 including the cleaning device 17 and second transfer device 16. In the present embodiment, a jam sensor 54 for detecting jamming of the recording medium 25 is arranged in the laser printer 11. The jam sensor 54 outputs to the controller 53 a signal indicating an occurrence or absence of jamming. An AIDC (Automatic Image Density Control) sensor 55 is arranged between the image forming unit 15D located in the most downstream of the direction of forwarding of the transfer belt 13 and the secondary transfer device 16.

As described later in detail, the controller 53 switches the rotation rate of the collection roller 32 between a standard rotation rate Rₛ and a high rotation rate Rₕ which is higher than the standard rotation rate Rₛ. In the present embodiment, when cleaning brush 41 is rotating at the standard rotation rate Rₛ, the ratio PV₁/PV₂ of the circumferential speed PV₁ of the cleaning brush 41 to the circumferential speed PV₂ of the transfer belt 12 is set to 1.5. Further, when cleaning brush 41 is rotating at the high rotation rate, the circumferential speed ratio PV₁/PV₂ is set to 2.0.

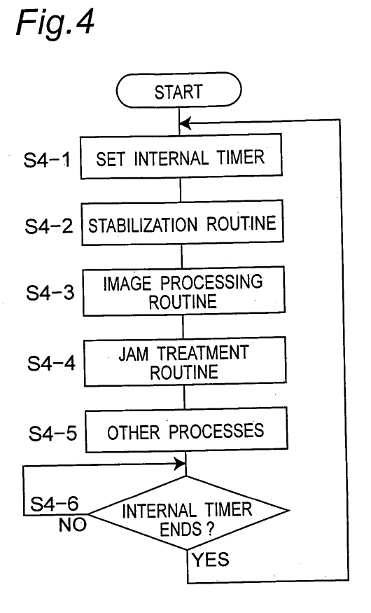

FIG. 4 shows the overall operation of the laser printer 11 of the present embodiment. An internal timer in steps S4-1 and S4-6 is used for performing the following routine operations in the same time period.

A stabilization process routine in step S4-2 includes an image density adjustment and a resist adjustment. In the image density adjustment, the image forming units 15A-15D form a plurality of rectangular toner patterns densities of which decrease gradually on the transfer belt 12. Then, on the basis of the densities of these toner patterns detected by the AIDC sensor 55, the amount of exposure is adjusted in the exposure device 20 of each of the image forming units 15A-15D. In the resist adjustment, the image forming units 15A-15D generate linear toner patterns. Then, the distance of these patterns is measured, so that the images of different colors generated by the image forming units 15A-15D are aligned with each other. While the stabilization process is executed, the stabilization process flag FLₛₜ is set to “1”. On the other hand, when the stabilization process is not executed, the stabilization process flag FLₛₜ is set to “”.

A jam treatment routine in step S4-3 is performed only when the jam sensor 54 detects the jamming. On completion of the process of the jam treatment routine, a jam-treated flag FLⱼ is set to “1”. In an image processing routine in step S4-4, the toner images generated by the image forming units 15A-15D are transferred actually onto the recording medium 25 via the transfer belt 12.

Other processes in step S4-5 includes a process of receiving data transmitted from a computer of a user and then converting the data into printing data, and a process of controlling an energy saving mode in which the power consumption is reduced in the fixing device and the like during a waiting status.

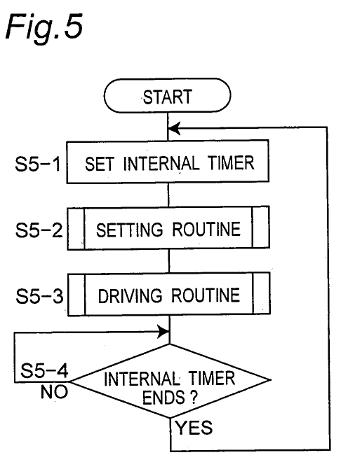

Then, the control of the cleaning device 17 and the secondary transfer device 16 by the controller 43 is described below with reference to FIGS. 5 to 8B. In FIG. 5, an internal timer in steps S5-1 and S5-4 is used for synchronizing the control cycles similarly to the case of FIG. 4. A setting routine in step S5-2 sets the rotation rate of the cleaning brush 41.

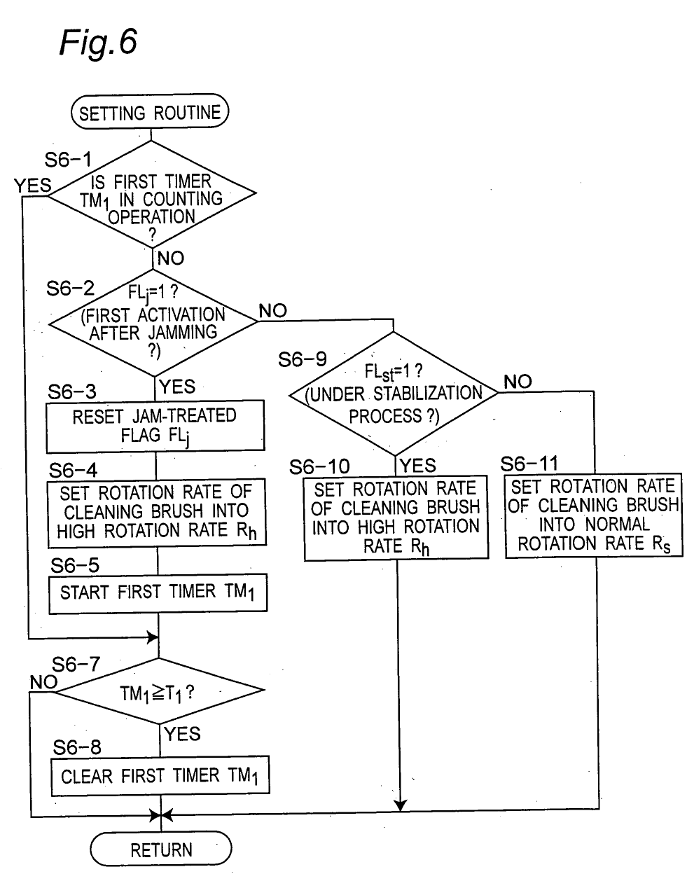

FIG. 6 shows the detail of the setting routine. In step S6-1, it is determined whether or not first timer TM₁ is in counting operation. The first timer TM₁ is used for setting the rotation rate of the of cleaning brush 41 at the high rotate rate Rₕ for a predetermined period of time T₁ at the time of a first operation after the jamming process has been carried out. In step S6-1, in the case that the first timer TM₁ is not counting operation, the procedure goes to step S6-2. On the other hand, in the case that first timer TM₁ is in counting operation in step S6-1, it is determined whether or not the first timer TM₁ has reached the time T₁ in step S6-7. If the first timer TM₁ has reached the time T₁, then the procedure goes to step S5-3 of FIG. 5 after first timer TM₁ has been cleared in step S6-8.

When the jam treated flag FLⱼ is “1” in step S6-2, i.e., in case that the first operation after the jamming process is carried out, jam treated flag FLj is reset to “0” in step S6-3, the rotation rate of the cleaning brush 41 is set to the high rotation rate Rₕ in step S6-4, and in addition, measurement of time by first timer TM₁ is started in step S6-5. After that, the procedure goes to step S6-7.

In the case that the jam treated flag FLⱼ is not “1” in step S6-2, i.e., in case that the first operation after the jamming process is not carried out, the procedure goes to step S6-9. In step S6-9, it is determined whether or not the stabilization process flag FLₛₜ is “1”, i.e. , whether or not the image stabilization process is under execution. If the stabilization process flag FLₛₜ is “1” (during the image stabilization process) in step S6-9, then rotation rate of the cleaning brush 41 is set to the high rotation rate Rₕ in step S6-10. On the other hand, if the stabilization process flag FLst is not “1” (not during the image stabilization process) in step S6-9, then the rotation rate of the cleaning brush 41 is set to the standard rotation rate Rₛ in step S6-11.

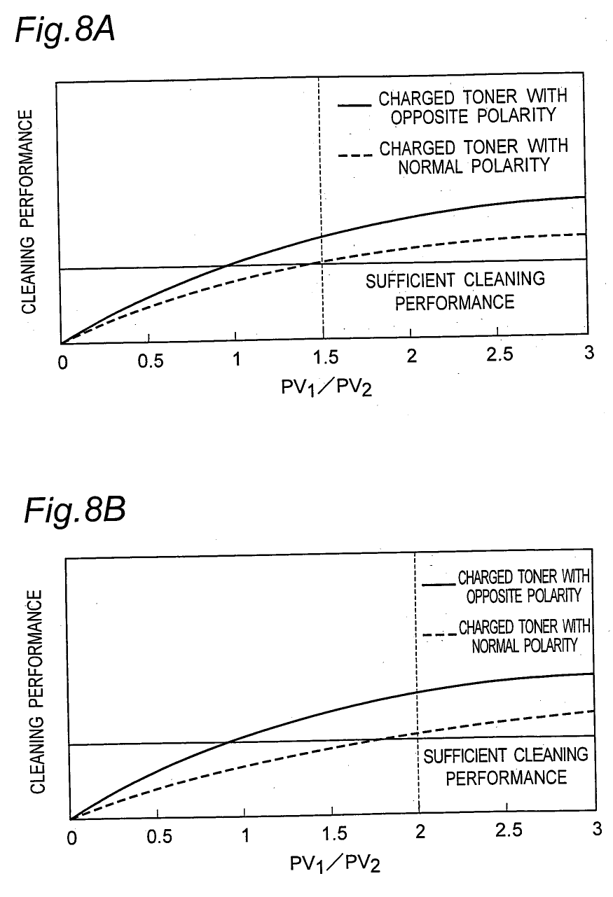

In the case that it is not within the time T1 after the start of the first operation after the jamming process and it is not during the image stabilization process, the rotation rate of the cleaning brush 41 is set to the standard rotation rate Rₛ (step S6-11). As described above, the circumferential speed ratio PV₁/PV₂ of the cleaning brush 41 to the transfer belt 12 when the rotation rate is set to the standard rotation rate Rₛ is 1.5. FIG. 8(A) shows the relationship between the circumferential speed ratio PV₁/PV₂ and cleaning performance of the cleaning device 17. In FIG. 8(A), the solid line indicates the case of toner 27 having the polarity of the normal charge (negative polarity in the present embodiment), and the broken line indicates the case of toner 27 having the reverse polarity (positive polarity in the present embodiment). As shown in this FIG. 8(A), the circumferential speed ratio PV₁/PV₂ not less than 1.5 achieves sufficient cleaning performance not only for the toner having the polarity of the normal charge but also for toner 27 charged to the negative polarity.

Within the time T₁ from starting of the first operation after the jam treatment process, or during the stabilization process, the rotation rate of cleaning brush 41 is set to the high rotation rate Rₕ (steps S6-4 and S6-10). As described above, at the time of the high rotation rate Rh, the circumferential speed ratio PV₁/PV₂ of the cleaning brush 41to the transfer belt 12 is 2.0. FIG. 8(B) shows the relationship between the circumferential speed ratio PV₁/PV₂ and the cleaning performance of cleaning device 17. The solid line indicates the case of toner 27 (remaining toner after transfer) having the polarity of the normal charge that remains on the transfer belt 12 after the toner image has been transferred onto recording medium 25 by secondary transfer device 16 and reaches the cleaning device 17. On the other hand, the broken line indicates the case of toner 27 (toner that has not yet been transferred) having the polarity of the normal charge that reaches cleaning device 17 without being transferred onto recording medium 25 by secondary transfer device 16. As shown in this FIG. 8(B), in the case that the circumferential speed ratio PV₁/PV₂ is approximately 1.5, a sufficient cleaning performance can be gained for the toner that remains after the transfer, whereas the cleaning performance for the toner that has not yet been transferred is insufficient. In the case where the circumferential speed ratio PV1/PV2 is not less than 2.0, however, a sufficient cleaning performance can be obtained for both of the toner that remains after the transfer and the toner that has not yet been transferred.

As described above, in the present embodiment, at the time of normal operation, the rotation rate of the cleaning brush 41 is set at the standard rotation rate Rₛ where the circumferential speed ratio PV₁/PV₂ is 1.5. On the other hand, after the jam treatment process and during the image stabilization process, the rotation rate of the cleaning brush 41 is set at the high rotation rate Rₕ where the circumferential speed ratio PV₁/PV₂ is 2.0. These setting of the rotation rate of the cleaning brush 41 achieve efficient removal of the toner 27 on the transfer belt 12.

The driving routine of step S5-3 of FIG. 5 controls the operation of cleaning device 17 in the stabilization process routine (step S4-2 of FIG. 4) and in the image process routine (step S4-4 of FIG. 4), as well as the operation of the secondary transfer device 16 relating to the operation of the cleaning device 17.

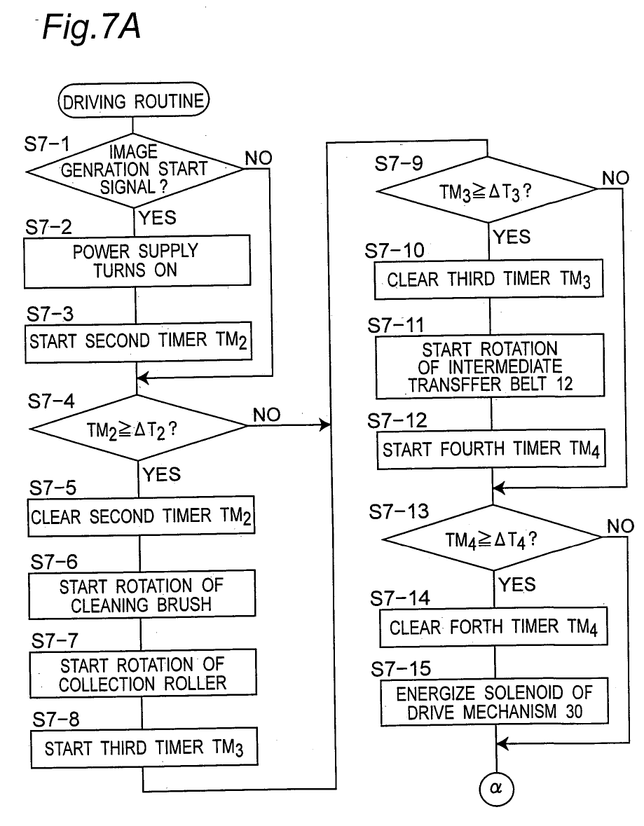

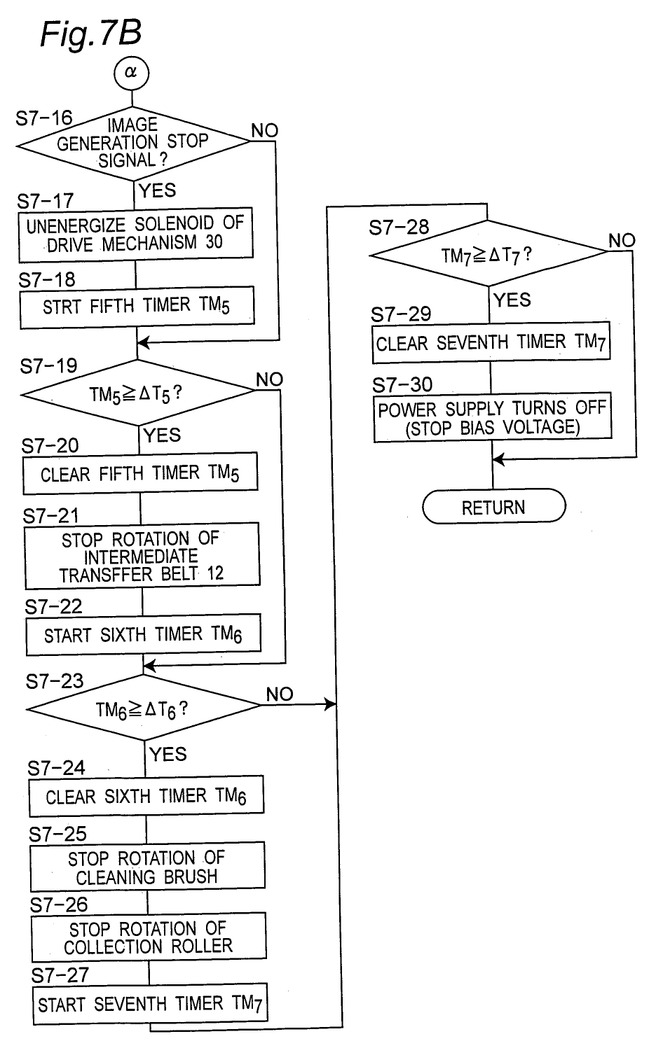

FIGS. 7A and 7B show the details of the driving routine. If an image formation start signal (signal that indicates the start of the image formation process in the image process routine or in the stabilization process routine) is inputted in step S7-1, then the power supply 51 for applying the bias voltage is energized in step S7-2. In addition, measurement of time by second timer TM₂ is started in step S7-3. This second timer TM₂ is used in order to start the rotation of cleaning brush 41 after a predetermined delay time ΔT₂ has passed after the starting of the application of the bias voltage to the cleaning brush 41. The delay time ΔT₂ is set at a value, for example, in the range from approximately 0.1 second to 1.0 second.

If the second timer TM₂ has not reached delay time ΔT₂ in step S7-4, then the procedure goes to S7-9. On the other hand, if the second timer TM₂ has reached the delay time ΔT₂ in step S7-4, the second timer TM₂ is cleared in step S7-5. In addition, the driving mechanism 48 begins to be activated so as to start the rotation of the cleaning brush 41 in step S7-6. Furthermore, the driving mechanism 49 begins to be activated so as to start the rotation of the collection roller 42 in step S7-7. Further, measurement of time of a third timer TM₃ is started in step S7-8, and subsequently, the process goes to step S7-9. The third timer TM₃ is used in order to start the movement of transfer belt 12 after a predetermined delay time ΔT₃ has passed after the start of the rotation of the cleaning brush 41. The delay time ΔT₃ is set at a value, for example, in the range from approximately 0.7 seconds to 2.0 seconds.

If the third timer TM₃ has not reached delay time ΔT₃ in step S7-9, then the procedure goes to step S7-13. On the other hand, if the third timer TM₃ has reached delay time ΔT₃ in step S7-9, then the third timer TM₃ is cleared in step S7-10. Further, the driving mechanism 14 is begins to be activated so as to start the rotation of the transfer belt 12 in step S7-11. Furthermore, measurement of time by a fourth timer TM₄ is started in step S7-12, and subsequently, the procedure goes to step S7-13. The fourth timer TM₄ is used in order to bring the secondary transfer roller 26 into contact with the transfer belt 12 after a predetermined delay time ΔT₄ has passed after the start of the movement of the transfer belt 12. The delay time ΔT₄ is set at a value, for example, in the range from approximately 0.7 seconds to 2.0 seconds.

If the fourth timer TM₄ has not reached delay time ΔT₄ in step S7-13, then the procedure goes to step S7-16. On the other hand, if the fourth timer TM₄ has reached delay time ΔT₄ in step S7-13, then the fourth timer TM₄ is cleared in step S7-14. Further, the solenoid of a driving mechanism 30 is energized in step S7-15. As a result of this, the plunger is placed in a protruding position, and the secondary transfer roller 26 shifts from the position where it is spaced to the transfer belt 12 as indicated by the two-dot chain line in FIG. 3 to the position where it is in contact with the transfer belt 12 as indicated by the solid line.

If an image formation completion signal (signal that indicates the completion of the image formation process in the image process routine or in the stabilization process routine) is inputted in step S7-16, then the solenoid of driving mechanism 30 stops being energized in step S7-17. As a result of this, the plunger moves to the retracted position, and the second transfer roller 26 shifts from the position where it is in contact with transfer belt 12 as indicated by the solid line in FIG. 3 to the position where it is spaced to the transfer belt 12 as indicated by the two-dot chain line. Further, measurement of time by a fifth timer TM₅ is started in step S7-18, and subsequently, the procedure goes to step S7-19. The fifth timer TM₅ is used in order to stop the movement of the transfer belt 12 after a predetermined delay time ΔT₅ has passed after the secondary transfer roller 26 has been spaced to the transfer belt 12. The delay time ΔT₅ is set at a value, for example, in the range from approximately 0.4 seconds to 1.0 second.

If the fifth timer TM₅ has not reached delay time ΔT₅ in step S7-19, then the procedure goes to step S7-23. On the other hand, if the fifth timer TM₅ has reached delay time ΔT₅ in step S7-19, then the fifth timer TM₅ is cleared in step S7-20. Further, the movement of transfer belt 12 is stopped in step S7-21. Furthermore, measurement of time of a sixth timer TM₆ is started in step S7-22, and subsequently, the procedure goes to step S7-23. The sixth timer TM₆ is used in order to stop the rotation of cleaning brush 41 after a predetermined delay time ΔT₆ has passed after the movement of the transfer belt 12 has stopped. The delay time ΔT₆ is set at a value, for example, in the range from approximately 1.0 second to 2.0 seconds.

If the sixth timer TM₆ has not reached delay time ΔT₆ in step S7-23, then the procedure goes to step S7-28. On the other hand, if the sixth timer TM₆ has reached delay time ΔT₆ in step S7-23, then the sixth timer TM₆ is cleared in step S7-24. Further, the rotation of cleaning brush 41 is stopped in step S7-25. Furthermore, the rotation of the collection roller 42 is stopped in step S7-26. In step S7-27, measurement of time by a seventh timer TM₇ is started, subsequently, the procedure goes to step S7-28. The seventh timer TM₇ is used in order to stop the application of a bias voltage to the cleaning brush 41 after a predetermined delay time ΔTM₇ has passed after the rotation of cleaning brush 41 has stopped. The delay time ΔT₇ is set at a value, for example, in the range from approximately 1.0 second to 2.0 seconds.

IF the seventh timer TM₇ has not reached delay time ΔT₇ in step S7-28, then the procedure returns to step S5-4 of FIG. 5. On the other hand, if the seventh timer TM₇ has reached delay time ΔT₇ in step S7-28, then the seventh timer TM₉ is cleared in step S7-29. Further, the power supply 51 is turned off so as to stop the application of the bias voltage to the cleaning brush 41 in step S7-30.

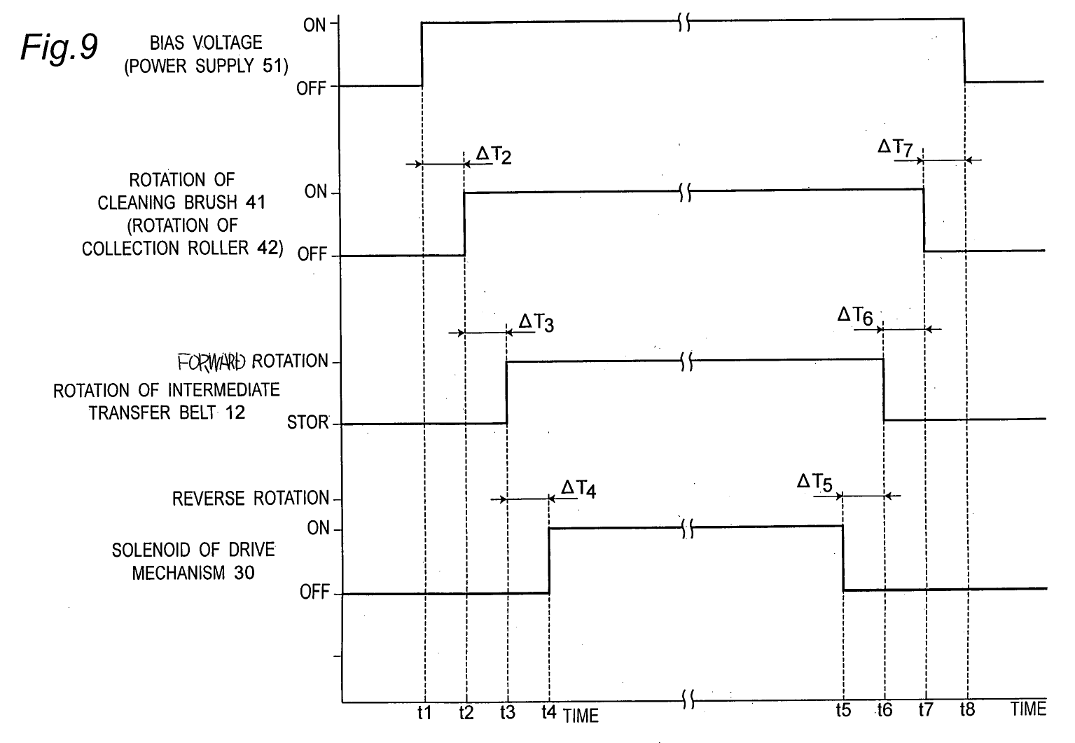

FIG. 9 shows an example of the operation of the laser printer 11 according to the first embodiment. When an image formation start signal is inputted at time t1, power supply 51 is turned on to start the application of the bias voltage to the cleaning brush 41 (step S7-2 of FIG. 7A) when delay time ΔT₂ has passed after time t1, the cleaning brush 41 begins to rotate at time t2, (step S7-6 of FIG. 7A). Therefore, mechanical scraping off of the toner 27 by the brush fibers 41b is started after the bias voltage has increased to a value sufficient for brush fibers 41b to electro-statically adsorb the toner 27. Accordingly, it can be prevented that the toner 27 remaining on the transfer belt 12 at the upstream side with respect to the nip portion pass through the nip portion without being removed by cleaning brush 41 to cause ineffective cleaning.

When the delay time ΔT₃ has passed after time t2 when cleaning brush 41 begins to rotate, the transfer belt 12 starts moving (in the forward rotational direction) at time t3. Accordingly, toner 27 remaining on the transfer belt 12 to the upstream side with respect to the nip portion passes through the nip portion after the bias voltage and the rotation rate of the cleaning brush 41 have sufficiently increased. In other words, the toner 27 remaining on the transfer belt 12 at the upstream side with respect to the nip portion passes through the nip portion after the effect of removal of the toner 27 by the electro-static adhesion and the effect of removal of the toner 27 by mechanical scraping off have sufficiently been enhanced. Accordingly, the toner 27 remaining on the transfer belt 12 at the upstream side with respect to the nip portion can be surely prevented from passing through the nip portion without being removed by the cleaning brush 41.

When the delay time Δt₄ has passed after the time t3 when the transfer belt 12 begins to rotate, the solenoid of the driving mechanism 30 begins to be energized at time t4. As a result of this, the secondary transfer roller 26 shifts from the position where it is spaced to the transfer belt 12 indicated by the two-dot chain line in FIG. 3 to the position where it is in contact with transfer belt 12 indicated by the solid line. The secondary transfer roller 26 makes contact with transfer belt 12 after toner 27 remaining on the transfer belt 12 at the upstream side with respect to the nip portion has been removed by the cleaning brush 41. Accordingly, it is prevented that the toner 27 remaining on the transfer belt 12 at the upstream side with respect to the nip portion adheres to the secondary transfer roller 26 to cause staining or the like on the rear side of the recording medium 25.

The image formation operation is carried out between time t4 and time t5. As described with reference to the flow chart of FIG. 6, within the time T₁ after the start of the first operation after jamming, or during the stabilization process, the rotation rate of the cleaning brush 41 is set to the high rotation rate Rₕ that is greater than the standard rotation rate Rₛ at the time of normal operation. Therefore, the toner not only remaining on the transfer belt 12 but also not transferred can be surely remained by the cleaning brush 41.

When an image formation completion signal is inputted at time t5, the solenoid of driving mechanism 30 stops being energized, and secondary transfer roller 26 shifts to the position where it is spaced to the transfer belt 12 indicated by the two-dot chain line in FIG. 3 (step S7-17 of FIG. 7B). When the delay time ΔT₅ has passed after the time t5, the transfer belt 12 stops moving at time t6 (step S7-21 of FIG. 7B). When the delay time ΔT₆ has passed after time t6, the cleaning brush 41 stops rotating at time t7 (step S7-25 of FIG. 7B). Until the delay time ΔT₆ has passed after the movement of transfer belt 12 has stopped, i.e., before transfer belt 12 has completely stopped moving, the cleaning brush 41 continues to rotate so that the effect of mechanical scraping off of the toner 27 from the transfer belt 12 by the brush fibers 41b is maintained. Accordingly, the toner 27 can be prevented from staying at the upstream side of the nip portion between the cleaning brush 41 and the transfer belt 12.

When cleaning brush 41 has stopped rotating after delay time ΔT₇ has additionally passed after time t7, the power supply 51 is turned off to stop the application of the bias voltage to the cleaning brush 41 at time t8 (step S7-30 of FIG. 7B). Until the delay time ΔT₇ has passed after cleaning brush 41 has stopped rotating, i.e., before the cleaning brush 41 has completely stopped rotating, the application of the bias voltage to the cleaning brush 41 is continued so that the effect of the electro-statically adsorption of the toner 27 on the transfer belt 12 to the brush fibers 41b can be maintained.

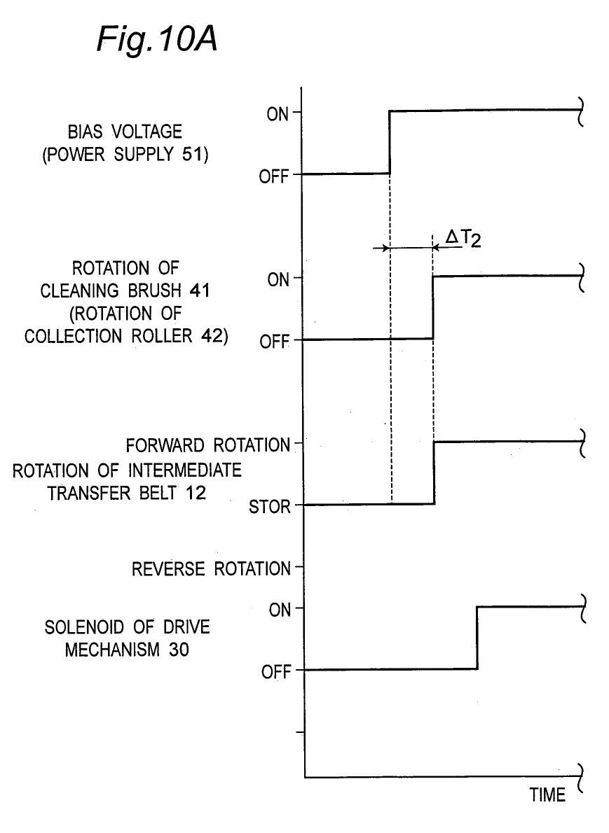

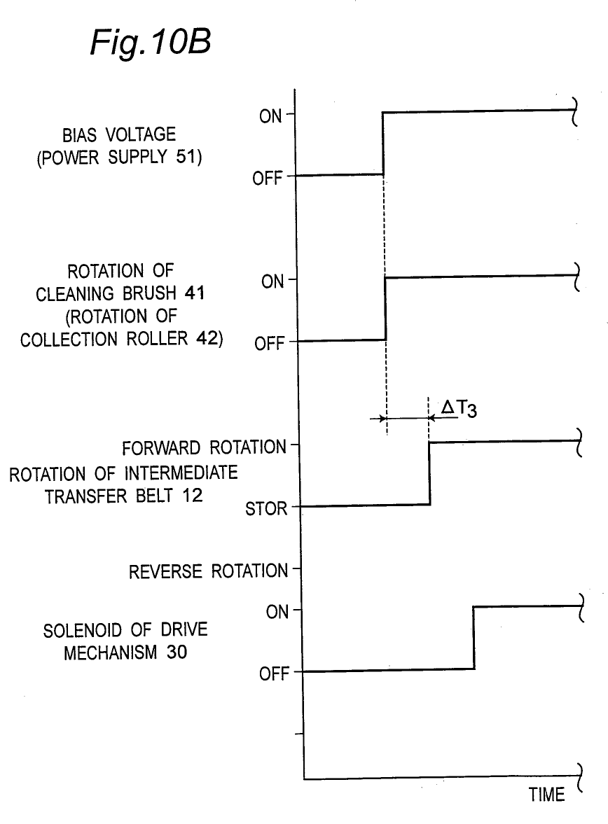

FIGS. 10A and 10B show two modifications of the first embodiment. These modifications both relate to the operation at the time of the start of the image formation. In the modification of FIG. 10A, the cleaning brush 41 begins to rotate when the delay time ΔT₂ has passed after the start of the application of a bias voltage to cleaning brush 41. However, the start of the rotation of the cleaning brush 41 and the start of the movement of transfer belt 12 are simultaneous without the delay time (delay time ΔT₃ of FIG. 9). In the modification of FIG. 10B, the transfer belt 12 begins to move after when the delay time ΔT₃ has passed after the start of the rotation of the cleaning brush 41. However, the start of the application of the bias voltage and the start of the rotation of the cleaning brush 41 are simultaneous,without the delay time (delay time ΔT₂ of FIG. 9).

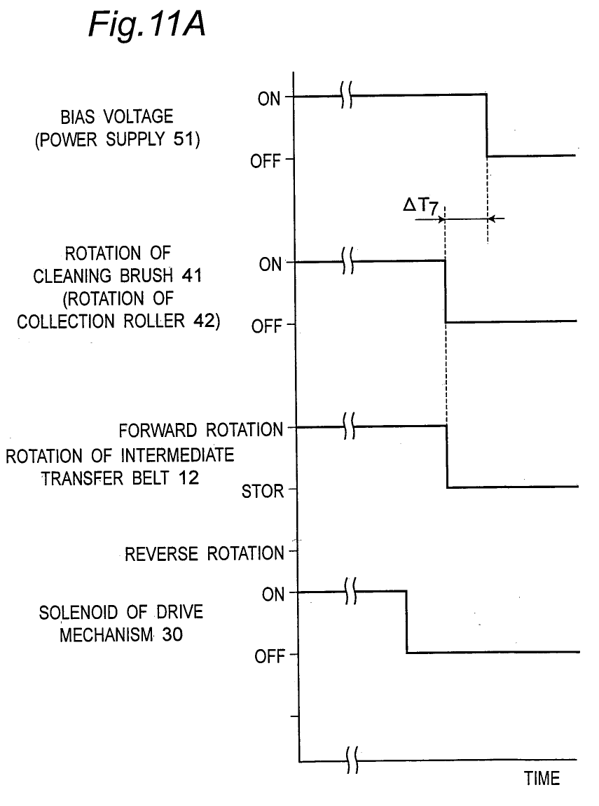

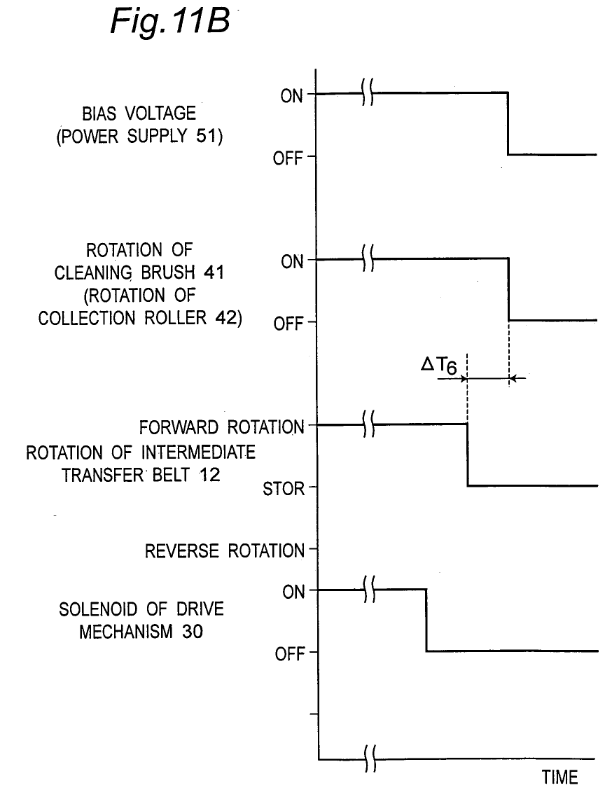

FIGS. 11A and 11B also show two modifications of the first embodiment. These modifications both relate to the operation at the time of completion of image formation. In the modification of FIG. 11A, the application of the bias voltage is stopped when the delay time ΔT₇ has passed after the cleaning brush 41 stops rotating. However, the stop of the movement of the transfer belt 12 and the stop of the rotation of the cleaning brush 41 are simultaneous without the delay time (delay time ΔT₆ of FIG. 9). In the modification of FIG. 11B, the cleaning brush 41 has stopped rotating when the delay time ΔT₆ has passed after the transfer belt 12 has stopped moving. However, the stop of the rotation of the cleaning brush 41 and the stop of the application of the bias voltage are simultaneous without the delay time (delay time ΔT₇ of FIG. 9).

### Second Embodiment

The second embodiment of the invention is a laser printer 11 having the same structure as that of the first embodiment. The overall operation (FIG. 4) and setting routine (step S5-2 of FIG. 5 and FIG. 6) of the second embodiment are the same as those of the first embodiment. The second embodiment differs from the first embodiment in the driving routine (step S5-3 of FIG. 5) executed by control section 53.

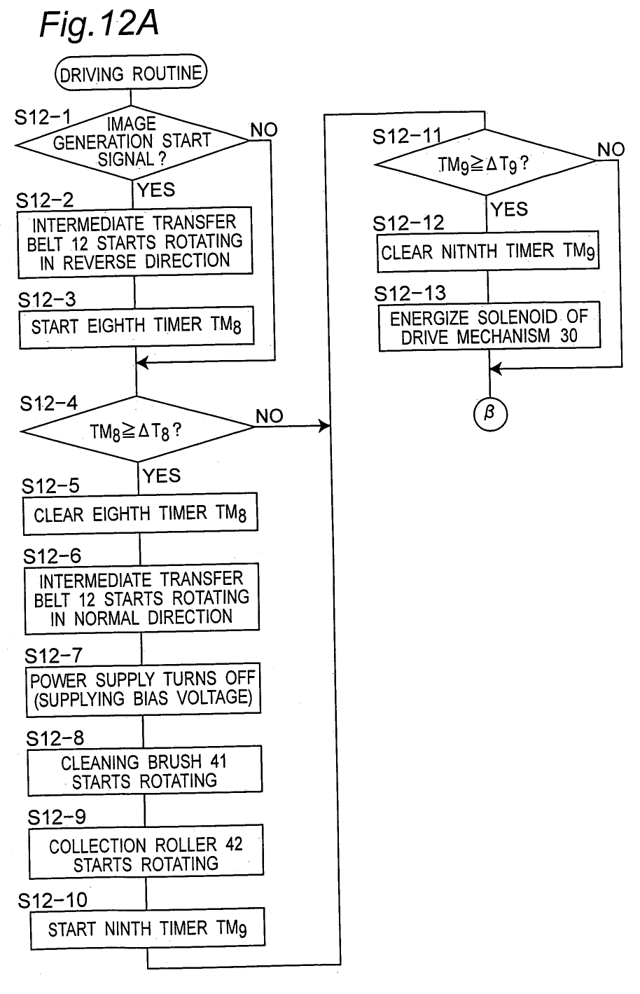

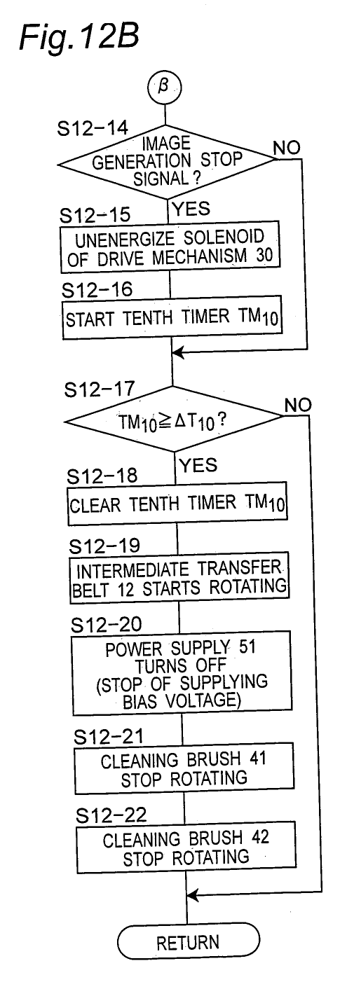

FIGS. 12A and 12B show the details of the drive routine in the second embodiment. When an image formation start signal is inputted in step S12-1, a driving mechanism 14 is activated in step S12-2 so as to start moving transfer belt 12 in the reverse rotational direction (arrow A2 of FIGS. 1 to 3). Further, measurement of time by an eighth timer TMₛ is started in step S12-3, and subsequently, the procedure goes to step S12-4. The Eighth timer TM₈ is used in order to move transfer belt 12 in the reverse rotational direction for a predetermined period of time T₈. The time T₈ is set at a value, for example, in the range from approximately 0.7 seconds to 2.0 seconds.

If the eighth timer TM₈ has not reached time T₈ in step S12-4, then the procedure goes to step S12-11. On the other hand, if the eighth timer TM₈ has reached time T₈ in step S12-4, then the eighth timer TM₈ is cleared in step S12-5. Further, the direction of the movement of the transfer belt 12 is switched from the reverse rotational direction to the forward rotational direction in step S12-6. Furthermore, the power supply 51 is turned on in step S12-7 so as to start the application of the bias voltage, cleaning brush 41 begins to rotate in step S12-8, and collection roller 42 begins rotate in step S12-9. Furthermore, the procedure goes to step S12-11 after measurement of time by a ninth timer TM₉ has been started in step S12-10. The ninth timer TM₉ is used in order that secondary transfer roller 26 make contact with the transfer belt 12 when a predetermined delay time ΔT₉ has passed after the start of the rotation of the cleaning brush 41. The ninth timer TM₉ has the same function as that of the fourth timer TM₄ of the first embodiment.

If the ninth timer TM₉ has not reached the delay time ΔT₉ in step S12-11, then the procedure goes to step S12-14. On the other hand, if the ninth timer TM₉ has reached the delay time ΔT₉ in step S12-11, the ninth timer TM₉ is cleared in step S12-12. Further, the solenoid of the driving mechanism 30 is energized in step S12-13. As a result of this, the plunger moves to the protruding position so that the secondary transfer roller 26 shifts from the position where it is spaced to the transfer belt 12 indicated by the two-dot chain line in FIG. 3 to the position where it is in contact with the transfer belt 12 indicated by the solid line.

When an image formation completion signal is inputted in step S12-14 the solenoid of driving mechanism 30 stops being energized in step S12-15. As a result of this, the plunger moves to the retracted position so that the secondary transfer roller 26 shifts from the position where it is in contact with the transfer belt 12 indicated by the solid line in FIG. 3 to the position where it is spaced to the transfer belt 12 indicated by the two-dot chain line. Further, measurement by a tenth timer TM₁₀ is started in step S12-16, and subsequently, the procedure goes to step S12-17. The tenth timer TM₁₀ is used in order to stop the movement of the transfer belt 12 when a predetermined delay time ΔT₁₀ has passed after the secondary transfer roller 26 has been separated from transfer belt 12. The tenth timer TM₁₀ has the same function as the fifth timer TM₅ of the first embodiment.

In the case where tenth timer TM₁₀ has not reached delay time ΔT₁₀ in step S12-17, the procedure goes to step S5-4 of FIG. 5. On the other hand, if the tenth timer TM₁₀ has reached the delay time ΔT₁₀ in step S12-17, then the tenth timer TM₁₀ is cleared in step S12-18. Further, the movement of transfer belt 12 is stopped in step S12-19, and the power supply 51 is turned off in step S12-20. Furthermore, the rotation of the cleaning brush 41 is stopped in step S12-21, and the rotation of the collection roller 42 is stopped in step S12-22.

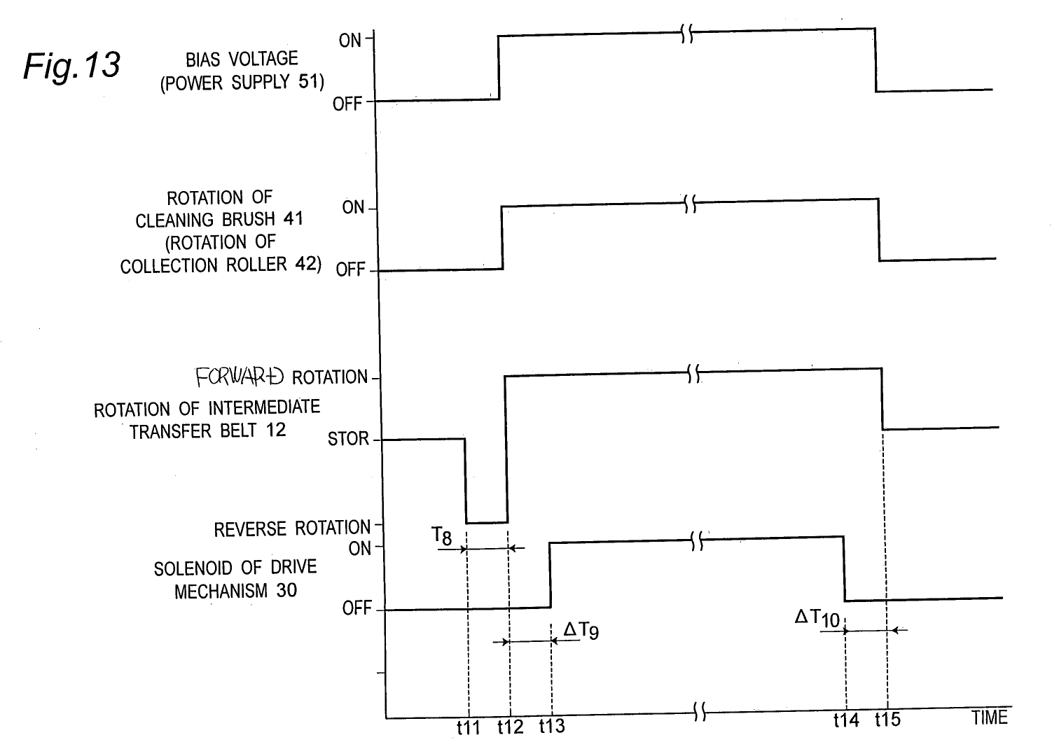

FIG. 13 shows an example of the operation of the laser printer 11 according to the second embodiment. When the image formation start signal is inputted at time t11, the transfer belt 12 moves for a period of time T₈ in the reverse rotational direction shown by the arrow A2 in FIGS. 1 to 3 (steps S12-2 to S12-4 of FIG. 12A). When the period of time T₈ has passed after time t11, the direction of the movement of transfer belt 12 is switched so that the transfer belt 12 begins to rotate in the forward rotational direction shown by the arrow A1 at time t12, (step S12-6 of FIG. 12A). Further, the application of the bias voltage to the cleaning brush 41, the rotation of the cleaning brush 41 and the rotation of the collection roller 42 are started at time t12 (steps S12-7 to S12-9 of FIG. 12A) when delay time ΔT₉ has passed after time t12, the secondary transfer roller 26 shifts to the position where it is in contact with transfer belt 12 at time t13, (step S12-13 of FIG. 12A). When the image formation completion signal is inputted at time t14, the secondary transfer roller 26 shifts to the position where it is spaced to the transfer belt 12 (step S12-5 of FIG. 12B). When the delay time ΔT₁₀ has passed, the application of the bias voltage, the rotation of the cleaning brush 41, the rotation of the collection roller 42 and the movement of the transfer belt 12 are stopped (steps S12-19 to S12-22 of FIG. 12B).

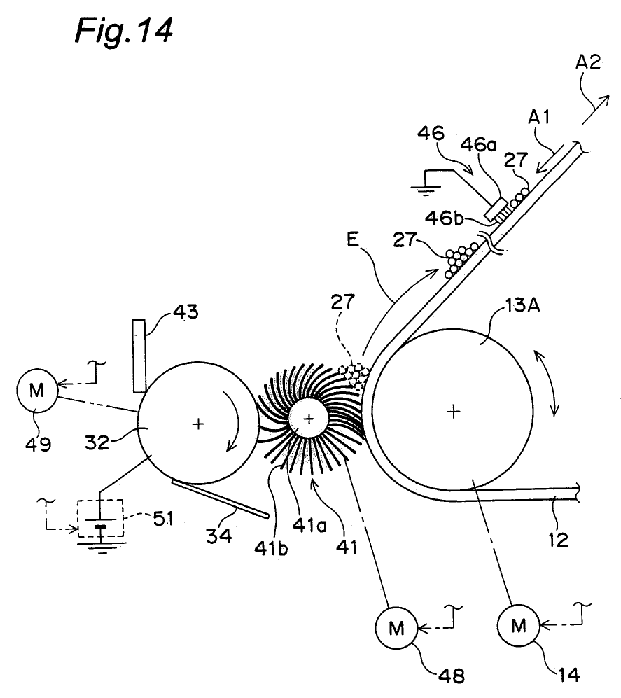

At the time of the start of the image formation operation, specifically, before the start of the application of the bias voltage to the cleaning brush 41, the start of the rotation of the cleaning brush 41, and the start of the movement of the transfer belt 12 (in the forward rotational direction), the transfer belt 12 is moved in the reverse rotational direction shown by the arrow A2 for the period of time T₈. As shown by an arrow E in FIG. 14, the reverse movement of the transfer belt 12 once carries the toner 27 remaining on the transfer belt 12 at the upstream side with respect to the nip portion between the cleaning brush 41 and the transfer belt 12 to the upstream side of the nip portion in the forward rotational direction of transfer belt 12. Accordingly, when transfer belt 12 moves in the forward rotational direction and toner 27 remaining on the upstream side of the nip portion passes through the nip portion, the bias voltage and the rotation rate of the cleaning brush 41 have already increased. Therefore, it is prevented that the toner 27 remaining on the transfer belt 12 at the upstream side of the nip portion passes through the nip portion without being removed by the cleaning brush 41. This avoids the insufficient cleaning.

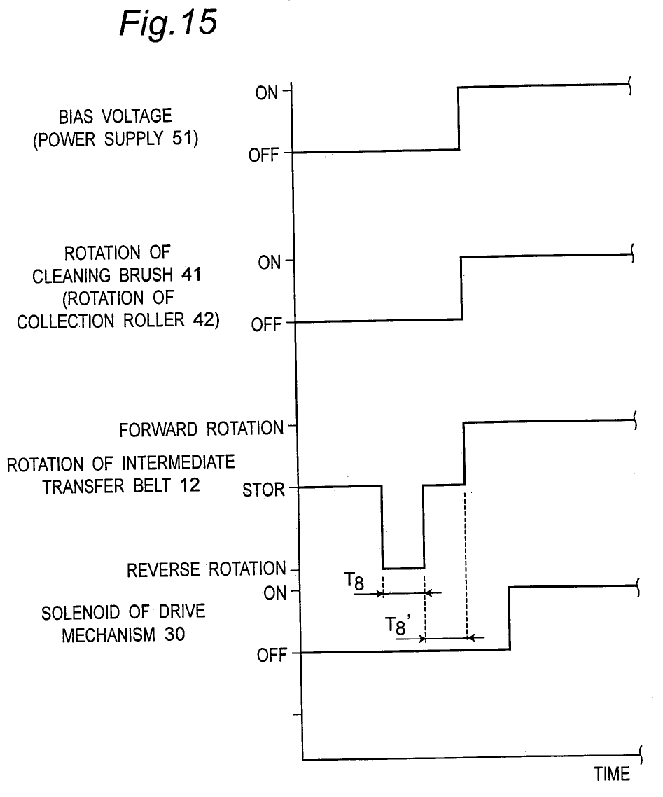

FIG. 15 shows a modification of the second embodiment. In this modification, after transfer belt 12 is moved in the reverse rotational direction for period of time T₈, the movement of transfer belt 12 is stopped for a period of time T₈′. After that, the application of the bias voltage and the rotation of the cleaning brush 41 are started at the same time as the start of the movement of the transfer belt 12 in the forward rotational direction.

### Third Embodiment

Although the transfer belt 12 is moved in the reverse rotational direction at the time of the start of the operation of the image formation in the second embodiment, the transfer belt 12 is moved in the reverse rotational direction at the time when the operation of the image formation is stopped in the third embodiment.

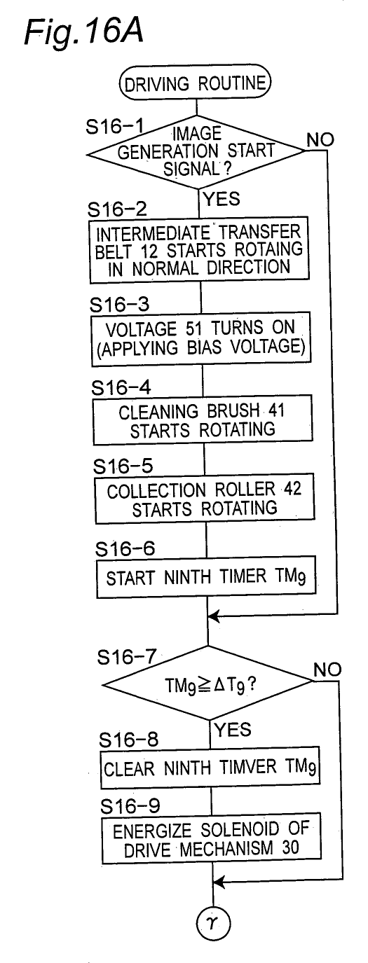

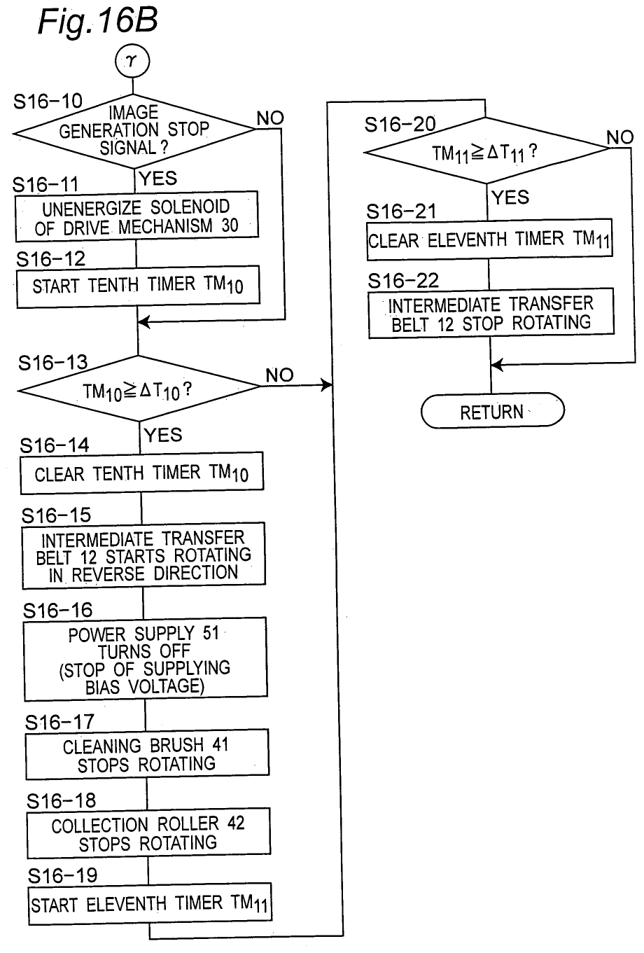

Referring to the flow chart of FIGS. 16A and 16B, when an image formation start signal is inputted in step S16-1, the movement of transfer belt 12 (in the forward rotational direction), the application of the bias voltage to the cleaning brush 41, the rotation of the cleaning brush 41, the rotation of the collection roller 42 and the measurement of time by the ninth timer TM₉ are started (steps S16-2 to S16-6). Further, after the delay time ΔT₉ has passed, the solenoid of the driving mechanism 30 is energized so that the secondary transfer roller 26 makes contact with the transfer belt 12 (steps S16-7 to S16-9).

When an image formation stop signal is inputted in step S16-10, the solenoid of the driving mechanism 30 stops being energized, and the secondary transfer roller 26 shifts to the position where it is spaced to the transfer belt 12. After tenth delay time ΔT₁₀ has passed, the direction of the movement of transfer belt 12 is switched so that the transfer belt 12 begins to rotate in the reverse rotational direction (steps S16-12 to S16-15). Simultaneously, the power supply 51 is turned off, and the rotations of the cleaning brush 41 and the collection roller 42 are stopped (steps S16-16 to S16-18). Further, an eleventh timer TM₁₁ starts measurement of time in step S16-19. The eleventh timer TM₁₁ is used in order to move the transfer belt 12 in the reverse rotational direction for a predetermined period of time T₁₁.

If the timer TM₁₁ has reached time T₁₁ in step S16-20, then the eleventh timer TM₁₁ is cleared in step S16-21, and the movement of transfer belt 12 is stopped in step S16-22.

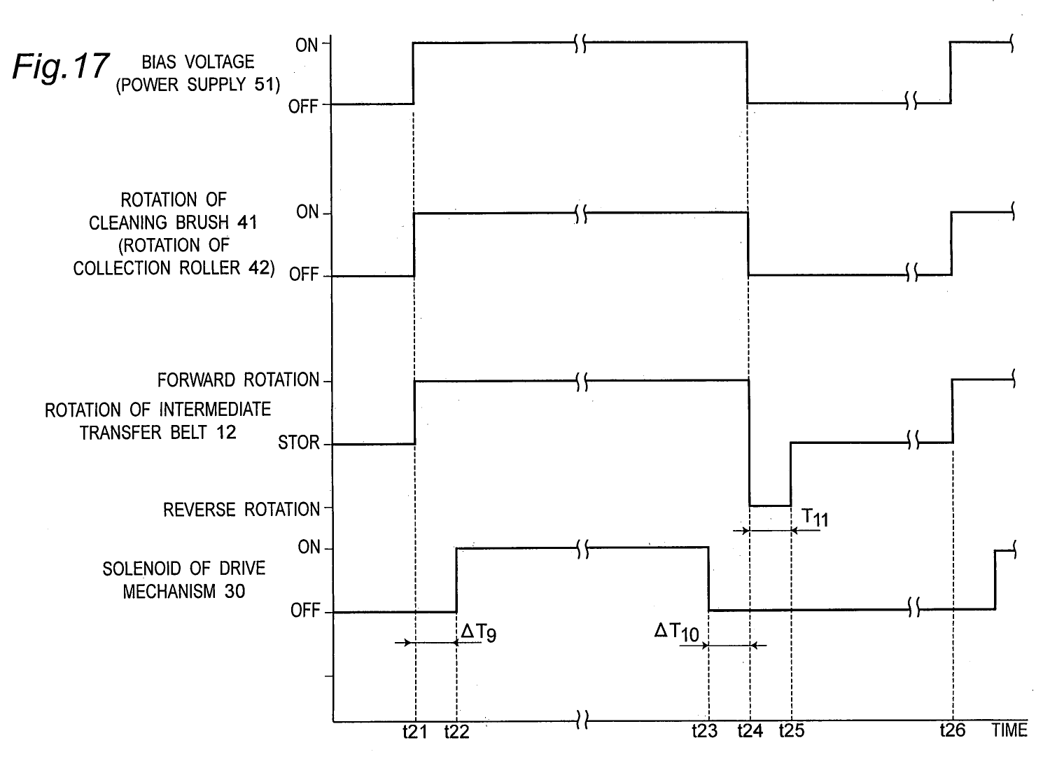

FIG. 17 shows an example of the operation of the laser printer 11 according to the third embodiment. When an image formation start signal is inputted at time t21, the application of the bias voltage, the rotation of the cleaning brush 41 and the collection roller 42, and the movement of the transfer belt 12 (in the forward rotational direction) are started (steps S16-1 to S16-5 of FIG. 16A). When delay time ΔT₉ has passed after time t21, the secondary transfer roller 26 shifts to the position where it is in contact with the transfer belt 12 at time t22 (steps S16-6 to S16-9 of FIG. 16A).

When an image formation stop signal is inputted at time t23, the secondary transfer roller 26 shifts to the position where it is spaced to the transfer belt 12 (steps S16-10 and S16-11 of FIG. 16B). Further, when delay time ΔT₁₀ has passed after time t23, the application of the bias voltage, the rotation of the cleaning brush 41 and the rotation of the collection roller 42 are stopped at time t24. Simultaneously to this, the direction of the movement of the transfer belt 12 is switched so that transfer belt 12 begins to move in the reverse rotational direction (steps S16-12 to S16-18 of FIG. 16B). When period of time T₁₁ has passed after time t24, the movement of transfer belt 12 in the reverse rotational direction is stopped at time t25 (steps S16-19 to S16-22).

At the time when the operation of image formation has stopped, specifically, after the completion of the application of the bias voltage to the cleaning brush 41, the completion of the rotation of the cleaning brush 41 and the completion of the movement of the transfer belt 12 (in the forward rotational direction), the transfer belt 12 is moved in the reverse rotational direction shown by arrow A2 for period of time T₁₁. This movement in the reverse rotational direction carries the toner 27 remaining on the transfer belt 12 at the upstream side with respect to the nip portion between the cleaning brush 41 and the transfer belt 12 to the upstream side in the forward rotational direction of the transfer belt 12, as shown by the arrow E of FIG. 14. Accordingly, when the movement of the transfer belt 12 in the forward rotational direction is started at the same time as the start of the application of the bias voltage and the rotation of the cleaning brush 41 at time t26 of FIG. 17, the toner 27 remaining at the upstream side of the nip portion reaches the nip portion after the bias voltage and the rotational speed of cleaning brush 41 have significantly increased.

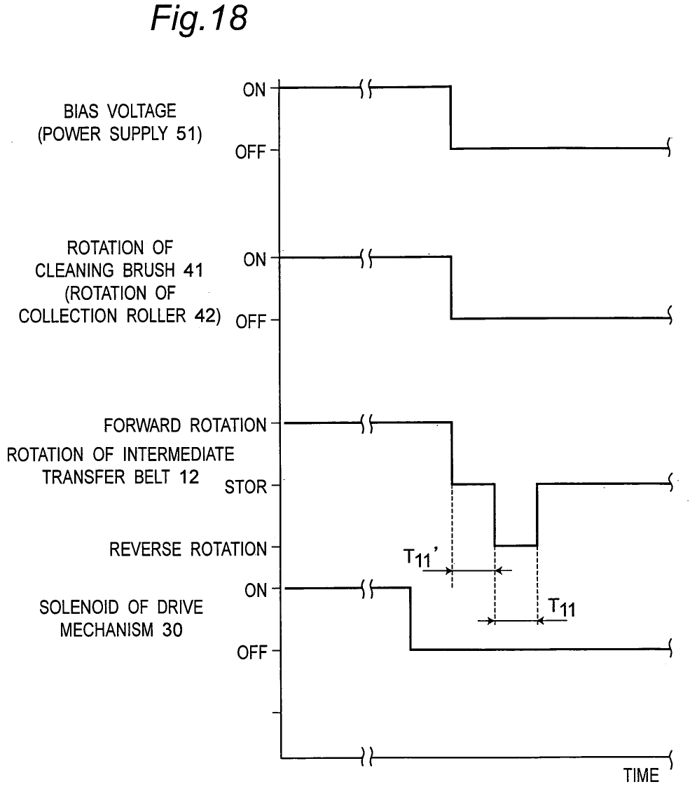

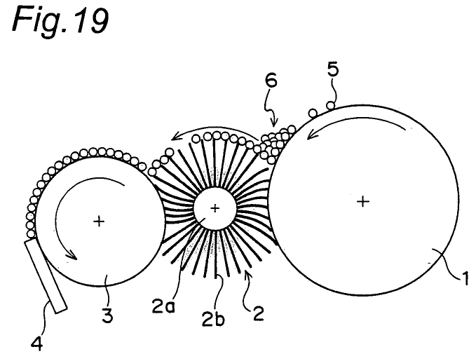

FIG. 18 shows a modification of the third embodiment. In this modification, the movement of transfer belt 12 is once stopped, together with the stop in the application of the bias voltage and the rotation of cleaning brush 41. Then, transfer belt 12 is moved in the reverse rotational direction for the period of time T₁₁ after a predetermined period of time T₁₁′ has passed after the stop in the movement.

Although the transfer belt 12 is moved reversely at the time of the start of the operation of the image formation in the second embodiment and at the time when the operation of image formation is stopped in the third embodiment, the timing for moving transfer belt reversely is not limited to these, but rather, the movement may be implemented between completion of one image formation operation and start of next image formation operation.

The present invention can be applied to a cleaning device for an intermediate transfer drum and photoconductive body including a photoconductive drum.

Further, in addition to a laser printer, the present invention can be applied to other image forming apparatuses, such as a copier, facsimile apparatus and multiple function machine of these machines.

Although the present invention has been fully described in conjunction with preferred embodiments thereof with reference to the accompanying drawings, various changes and modifications are possible for those skilled in the art. Therefore, such changes and modifications should be construed as included in the present invention unless they depart from the intention and scope of the invention as-defined by the appended claims.

What is claimed is:

1. An image forming apparatus comprising:
an image bearing body for bearing a toner image on a surface thereof;
a cleaning brush with a plurality of brush fibers on an outer periphery arranged so as to be rotatable in a state that the brush fibers are contacting with the image bearing body;
a first driving section for rotating the cleaning brush;
a bias voltage apply section for applying a bias voltage to the cleaning brush; and.
a control section for controlling the first driving section and the bias voltage application section so that the cleaning brush begins to rotate after a predetermined first delay time has passed from starting of an application of the bias voltage to the cleaning brush.

2. The image forming apparatus as claimed in claim 1, further comprising a second driving section for rotating the image bearing body,
wherein the control section controls the second driving section so that the image bearing body begins to rotate after a predetermined second delay time has passed from starting of the rotation of the cleaning brush.

3. The image forming apparatus as claimed in claim 2, further comprising a rotatable transfer roller for transferring the toner image on the image bearing body to a recording medium; and
a third driving section for moving the transfer roller between a first position where the transfer roller is in contact with the image bearing body and a second position where the transfer roller is spaced to the image bearing body,
wherein the control section controls the third driving section so that the transfer roller shifts from the second position to the first position after a predetermined third delay time has passed from starting of the rotation of the image bearing body.

4. The image forming apparatus as claimed in claim 1, wherein the control section controls the first driving section and the bias voltage application section so that the application of the bias voltage to the cleaning brush is stopped when a predetermined fourth delay time has passed after the rotation of the cleaning brush has stopped.

5. The image forming apparatus as claimed in claim 2, wherein the control section controls the first driving section and the second driving section so that the rotation of the cleaning brush is stopped when a predetermined fifth delay time has passed after the rotation of the image bearing body has stopped.

6. An image forming apparatus, comprising:
a rotatable image bearing body for bearing a toner image on a surface thereof;
a first driving section for rotating the image bearing body;
a cleaning brush with a plurality of brush fibers on an outer periphery arranged so as to be rotatable in a state that brush fibers are contacting with the image bearing body;
a second driving section for rotating the cleaning brush;
a bias voltage applying section for applying a bias voltage to the cleaning brush; and
a control section for controlling the first driving section, second driving section, and bias voltage applying section so that the image bearing body rotates in a forward rotational direction, the cleaning brush rotates, and the bias voltage is applied to the cleaning brush during the image formation operation, and the image bearing body rotates in a reverse rotational direction for a predetermined period of time after a completion of one image formation operation and before a start of a next image formation operation.

7. The image forming apparatus as claimed in claim 6, wherein the control section controls the first driving section, second driving section, and bias voltage applying section so that at starting of the image formation, the rotation of the image bearing body in the forward rotational direction, the rotation of the cleaning brush, and the application of a bias voltage to the cleaning brush are started after the rotation of the image bearing body in the reverse rotational direction for the predetermined period of time.

8. The image forming apparatus as claimed in claim 6, wherein the control section controls the first driving section, second driving section, and bias voltage applying section so that while the image formation is stopped, the rotation of the cleaning brush and the application of the bias voltage are started after the image bearing body rotates in the reverse rotational direction for a predetermined period of time.

9. The image forming apparatus as claimed in claim 7 or 8, further comprising:
a rotatable transfer roller for transferring the toner image on the image bearing body onto a recording medium; and
a third driving section for moving the transfer roller between a first position where the transfer roller is in contact with the image bearing body and a second position where the transfer roller is spaced to the image bearing body,
wherein the control section controls the third driving section so that at the starting of the imager formation operation, the transfer roller shifts from the second position to the first position when a predetermined delay time has passed after the starting of the rotation of the image bearing body in the forward rotational direction.

10. An image forming apparatus comprising:
an image bearing body for bearing a toner image on a surface thereof;
a transfer device for transferring the toner image formed on the image bearing body onto a recording medium;
a cleaning brush with a plurality of brush fibers on an outer periphery placed so as to be rotatable in a state that the brush fibers are in contact with the image bearing body;
a driving section for rotating the cleaning brush; and
a control section for controlling the driving section so that a rotational speed of the cleaning brush are increased after an occurrence of jamming of the recording medium.

11. An image forming apparatus comprising:
an image bearing body for bearing a toner image on a surface thereof;
a transfer device for transferring the toner image formed on the image bearing body onto a recording medium;
a cleaning brush with a plurality of brush fibers on an outer periphery placed so as to be rotatable in a state that the brush fibers are in contact with the image bearing body;
a driving section for rotating the cleaning brush; and
a control section for controlling the driving section so that a rotational speed of the cleaning brush are increased during an image stabilization process.
